(19) United States
(12) Patent Application Publication
(10) Pub. No.: US 2017/0093700 A1
(43) Pub. Date: Mar. 30, 2017

(54) DEVICE PLATFORM INTEGRATING DISPARATE DATA SOURCES

(71) Applicant: WoT. io, Inc., New York, NY (US)

(72) Inventors: Thomas GILLEY, New York, NY (US); David J. Goehrig, Buffalo, NY (US)

(21) Appl. No.: 14/872,050

(22) Filed: Sep. 30, 2015

(51) Int. Cl. H04L 12/721; H04L 29/06

(52) U.S. Cl. CPC H04L 45/44; H04L 63/20; H04L 69/08

(57) ABSTRACT

A computer-based platform for receiving data from disparate data sources and making the disparate data available for combinations by users into different data products and services is provided. Data from disparate data sources are authenticated and provided to a routing program. The routing program then transmits the data over an internal bus, providing each data source in a URL-addressable format, so that data can be used by different data consumer programs in an easy to combine manner.

### BACKGROUND OF THE INVENTION

The present invention relates to a computer system coupled to a data communication network, and more particularly, is directed to a computer-based platform for receiving data from disparate data sources and making the received data available for combinations into different data products and services, the combinations made by users.

Software as a service (SaaS) is a generic term for a software licensing and delivery model in which software is licensed on a subscription basis and is centrally hosted.

Platform as a service (PaaS) is a generic term for a computing services business model that enables customers to develop, run and manage Internet applications without building and maintaining infrastructure conventionally required for Internet applications.

The Internet of Things (IoT) is the network of physical objects or “things” embedded with electronics, software, sensors, and connectivity to enable objects to exchange data with the production, operator and/or other connected devices. The Internet of Things allows objects to be sensed and controlled remotely across existing network infrastructure, creating opportunities for more direct integration between the physical world and computer-based systems, and resulting in improved efficiency, accuracy and economic benefit. Each thing is uniquely identifiable through its embedded computing system but is able to interoperate within the existing Internet infrastructure. Experts estimate that the IoT will consist of almost 50 billion objects by 2020.

An IoT platform provides device management, data storage and data processing, so that application programs can use data from, and control data sent to, a relatively large set of devices without managing the details of the devices. Experts state that IoT market growth will require interoperability of IoT platforms, including that users should be able to avail themselves of data collected by different platforms. Most IoT platforms, while claiming to be open, are actually built around a single standard, and typically are based on pre-existing software. Accordingly, these IoT platforms have difficulty providing platform interoperability.

Thus, there is a need for an improved IoT platform.

### SUMMARY OF THE INVENTION

In accordance with an aspect of this invention, there is provided a system for enabling a first data consumer to create a first data product. A first protocol adapter receives first data from a first data source in a first protocol, and extracts first payload data from the received first data, the first data source operating independently of the first data consumer. A routing engine routes the extracted first payload data in accordance with a first routing rule. A second protocol adapter receives the routed first payload data from the routing program, and encapsulates the received first payload data according to a second protocol different than the first protocol, the second protocol being associated with the first data consumer. The first data consumer receives the encapsulated first data and creates the first data product based on the first payload data.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1A is a high-level block diagram of a data services exchange and its users;

FIG. 1B is a chart showing the relevant OSI model layers for the data services exchange;

FIG. 2A is a configuration diagram of the environment of a data services exchange;

FIG. 2B is a diagram showing the software of the data services exchange;

FIG. 2C is a diagram showing a partial view of the configuration in a data services exchange;

FIGS. 3A-3B are charts showing how information is passed within the data services exchange;

FIGS. 4A-4B are flowcharts showing incoming and outgoing traffic operation of a secure socket proxy program in the data services exchange;

FIGS. 5A-5B are flowcharts showing incoming and outgoing traffic operation of a caching reverse proxy program in the data services exchange;

FIG. 6 is a flowchart showing incoming and outgoing traffic operation of an application adapter program in the data services exchange;

FIGS. 7A-7J are a flowchart showing operation of a protocol adapter program in the data services exchange;

FIG. 8 is a flowchart showing operation of a routing engine program in the data services exchange; and

FIGS. 9 and 10A-10B are diagrams used in explaining use cases of the data services exchange.

### DETAILED DESCRIPTION

Where an example is provided, it should be understood that other examples are also possible, that is, “such as” should be interpreted as “such as but not limited to”. As used herein, “conventional” means publicly known prior to the filing date of this application. As used herein, “authentication” refers to the process of validation of identity for an entity, whereas “authorization” refers to the process of granting rights to an identified entity.

A computer-based platform for receiving data from disparate data sources and making the disparate data available for combinations by users into different data products and services, referred to as the data services exchange (DSE), is explained herein. Data from disparate data sources are authenticated and provided to a routing program. The routing program then transmits the data over an internal bus, providing each data source identified by a single URI and addressable by multiple protocol-specific URLs, so that data can be used by different data consumer programs in an easy to combine manner.

In a conventional device platform, data from each data source is provided to the platform, then a custom one-to-one adapter program is written to enable each data recipient to use the source data. In contrast to a conventional device platform, in the data services exchange, the data from the routing program is exposed so it can be used by interested user programs that were unknown when the data sources were configured.

In a conventional enterprise service bus (ESB), application programs access the bus via message brokers; the message brokers convert data to and from a normalized canonical format used on the bus. Payload data on the enterprise bus is accompanied by an envelope that provides routing for the data, e.g., from sales to billing to inventory to shipping to accounts receivable, based on the traditional paper model of sending “carbon copies”, often on different color paper, in manila envelopes each having a re-usable red string, to different departments. In contrast to a conventional enterprise service bus, in the data services exchange, the routing program supports both data stream and messaging transports without conversion to a normalized canonical format. Additionally, the data services exchange does not use an envelope to route data, instead, the routing program uses routing rules based on the nature of the data.

In a conventional publish and subscribe (“pub/sub”) configuration, each of the client and server must maintain session state, and a connection between the publisher and subscriber is needed. In contrast to a conventional publish and subscribe model, each data source in the data services exchange is typically unaware of consumers of its data, and a consumer can receive data from a source without a connection therebetween.

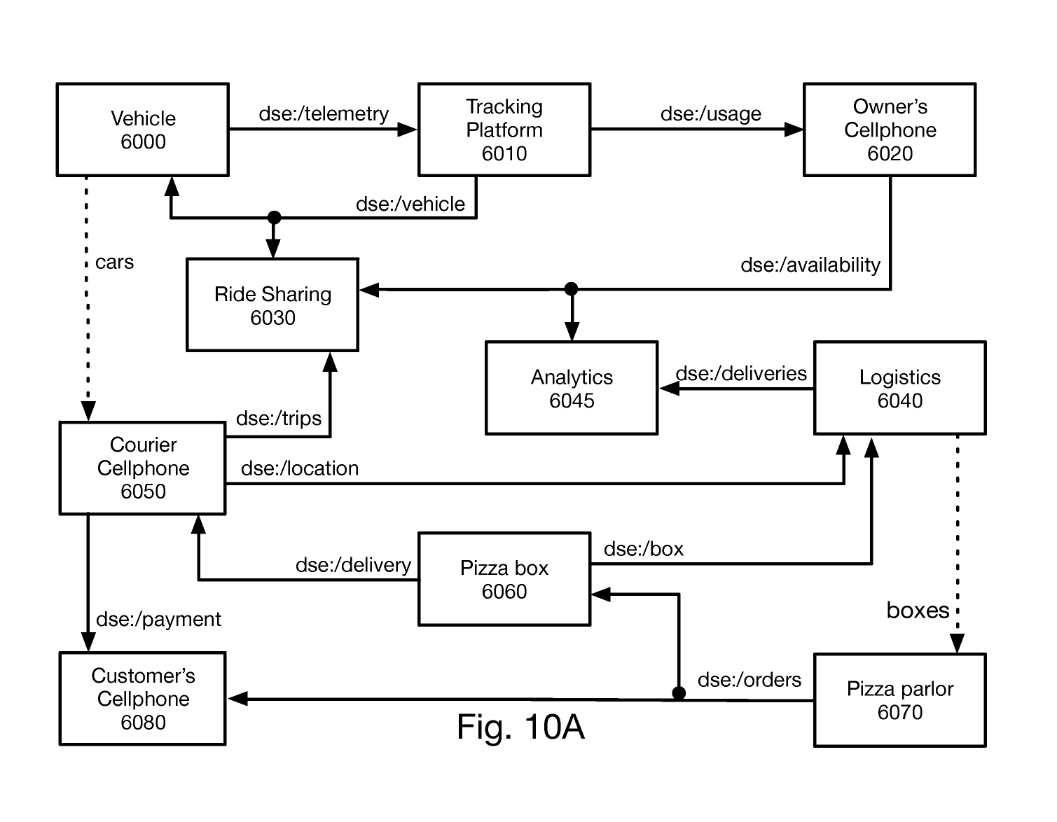

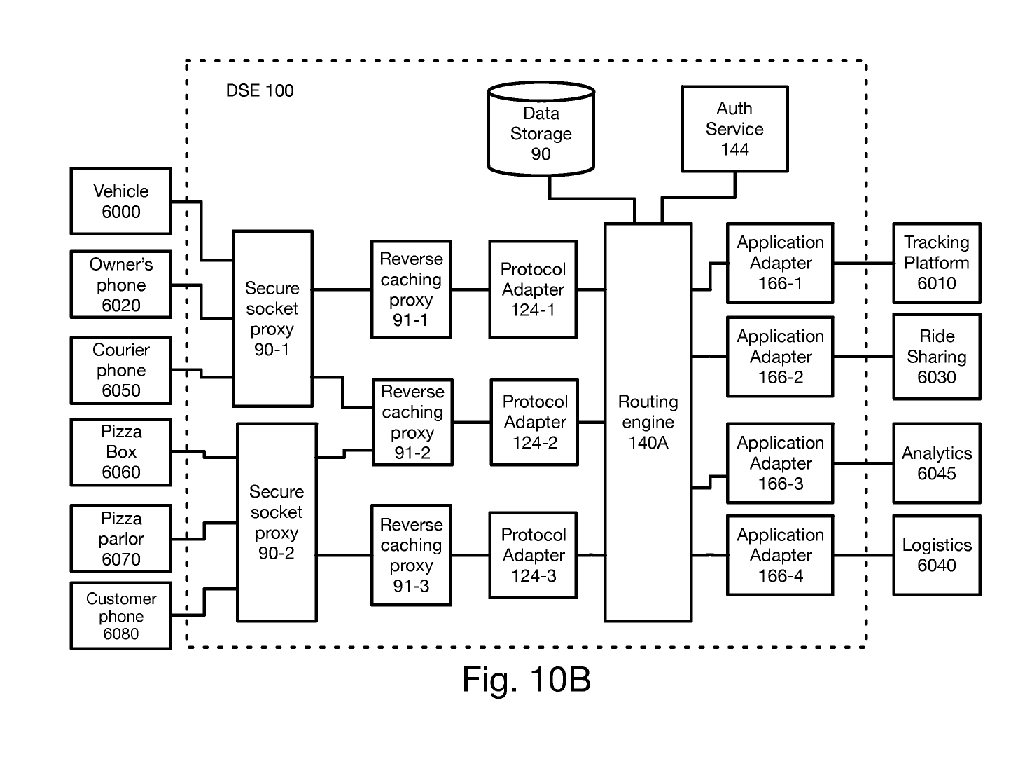

FIG. 10 is a chart showing the Open Systems Interconnection (OSI) seven layer model, discussed in ISO/IEC 7498-1, used for characterizing the communication functions of a computing system, to promote interoperability of diverse systems with standard protocols. The data services exchange implements layers 3-7 of the OSI model without requiring session awareness from a data source or from a data consumer.

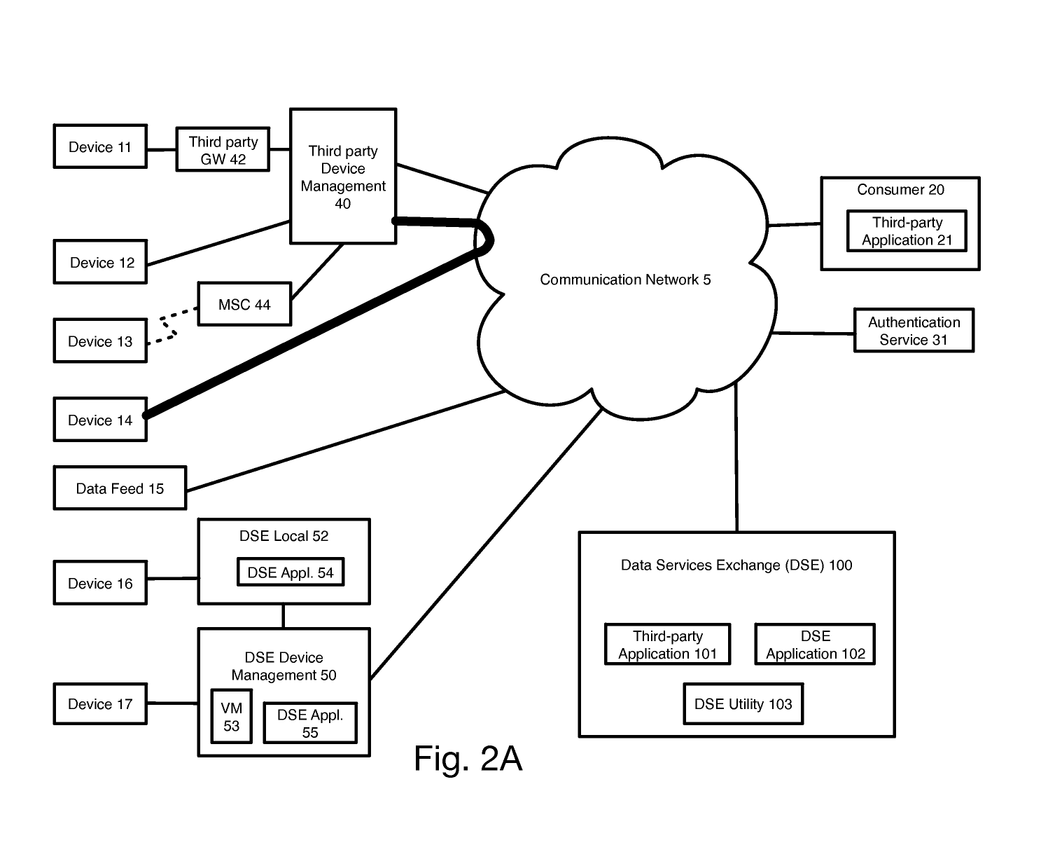

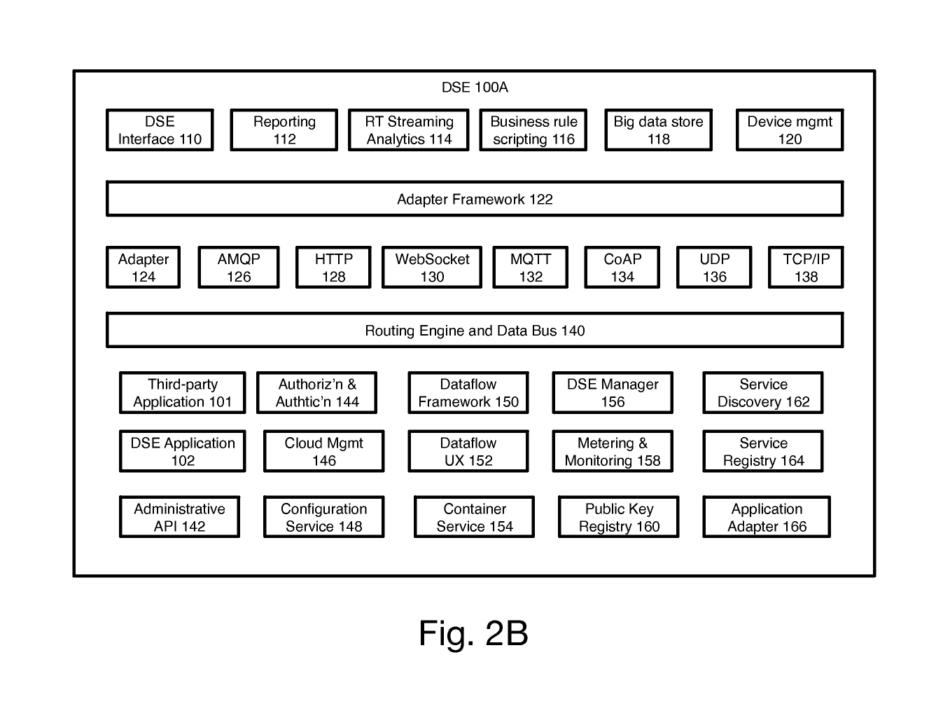

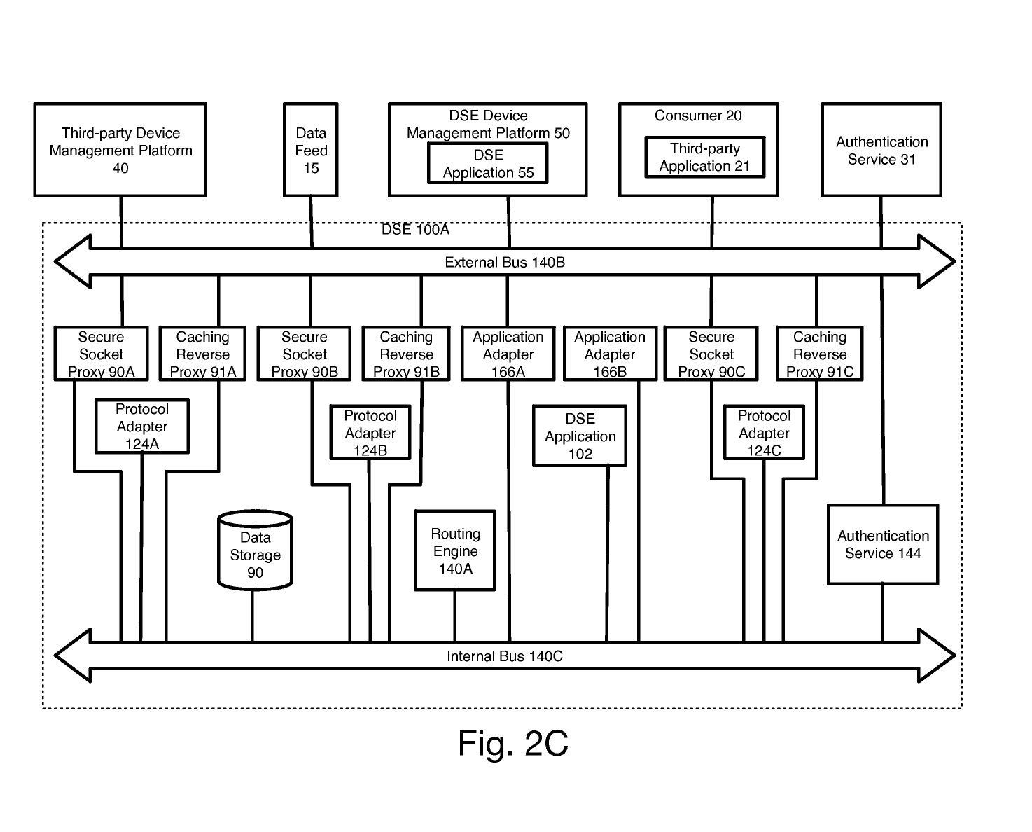

Conventional layer 7 application protocols includes:
enterprise service bus such as WSO2, an open source service-oriented architecture, see www.wso2com;
hypertext transfer protocol (HTTP) used by Bluemix, an IoT platform, see www.ibm.com/cloud-computing/bluemix/;
MQTT, see discussion of FIG. 2B below;
AMQP, implemented by RabbitMQ open source message broker software, see www.rabbitmq.com, see discussion of FIG. 2B below;
CoAP, see discussion of FIG. 2B below;
WebSocket, see discussion of FIG. 2B below;
Publish/subscribe, see discussion above.

Conventional layer 6 presentation protocols include: transport layer security (TLS), see Internet Engineering Task Force (IETF) Request for Comments (RFC) 5746, at tools.ietf.org/html/rfc5746.

Conventional layer 5 session protocols include: TCP, see discussion of FIG. 2B below.

Conventional layer 4 transport protocols include: UDP, see discussion of FIG. 2B below.

Conventional layer 3 network protocols include: IPv4, see IETF RFC 791, IPv6, see IETF RFC 2460, and virtual switch redundancy protocol (VSRP), a proprietary protocol combining OSI layers 2 and 3, sold in products manufactured by Brocade Communications Systems and Hewlett-Packard.

Conventional layer 2 data link protocols include: Ethernet, see IEEE 802.3 standard, address resolution protocol (ARP), see IETF RFC 826, and asynchronous transfer mode (ATM), see ITU-T Rec. 1.150 (02/99) B-ISDN Asynchronous Transfer Mode Functional Characteristics.

Conventional layer 1 physical protocols include: Ethernet, see IEEE 802.3 standard, Bluetooth, see IEEE 802.15.1 standard, controller area network (CAN) bus, see ISO 11898-1 (data link layer) and ISO 11898-2 (physical layer for high-speed CAN), ISO 11898-3 (physical layer for low-speed fault-tolerant CAN), and universal serial bus (USB), see www.usb.org.

The Internet of Things uses the Internet as its communication network. However, IoT is a subset of connected device platforms. For instance, a mobile network that is otherwise similar to IoT is usually referred to as a mobile-to-mobile (M2M) network. Additionally, there are private networks for similar purposes, such as Echelon Ionworks and bacnet.

International Telecommunications Union (ITU) Recommendation ITU-T Y.2060, “Overview of the Internet of Things”, June 2012, available at www.itu.int/ITU-T/recommendations/rec.aspx?rec=y.2060 (the “ITU IoT”) is hereby incorporated by reference in its entirety.

The ITU IoT Appendix describes five IoT business models from the perspective of telecommunications service and network operators. In model 1, the provider—such as smart grid and intelligent transport systems businesses—operates the device, network, platform and applications and serves the application customer directly. In model 2, a first provider—such as a telecommunications operator—operates the device, network and platform, while a second provider operates the application and serves the application customers. In model 3, a first provider—such as a telecommunications operator—operates the network and platform, while a second provider operates the device and applications and serves the application customers. In model 4, a first provider—such as a telecommunications operator—operates the network, while a second provider operates the device and platform. In model 5, a first provider—such as a telecommunications operator—operates the network, a second provider operates the platform, and a third provider—such as a vertically integrated business—operates devices and provides applications to the application customers.

A problem with the ITU IoT models is that in the real world there are more than one connected device platform providers, often a collection of legacy and planned new implementations, an end-user customer wishing to integrate data from disparate providers will be forced to do a tremendous amount of work for each data set, probably including accommodating fundamentally different approaches to reality inherent in different data sets, thereby discouraging the sort of integration that leads to wonderful new services.

The present invention instead assumes that end-users will want to combine data collected in different ways, in different combinations that cannot be presently predicted. Data from disparate sources is collected, processed and stored according to a model that helps make the meaning of the data more explicit. To properly use the data, an end-user must understand the model, then it is relatively easy to combine data from disparate sources, in real-time as the data is collected, and/or after the data has been stored. Thus, the present invention encourages the creation of wonderful new data products and derives actionable value from the device data for an enterprise.

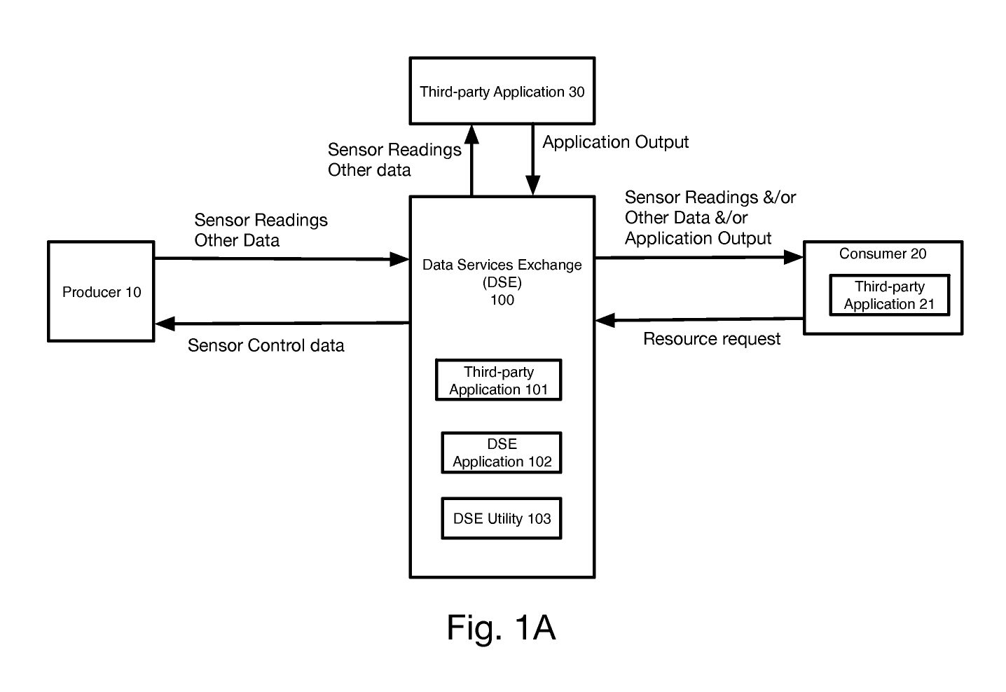

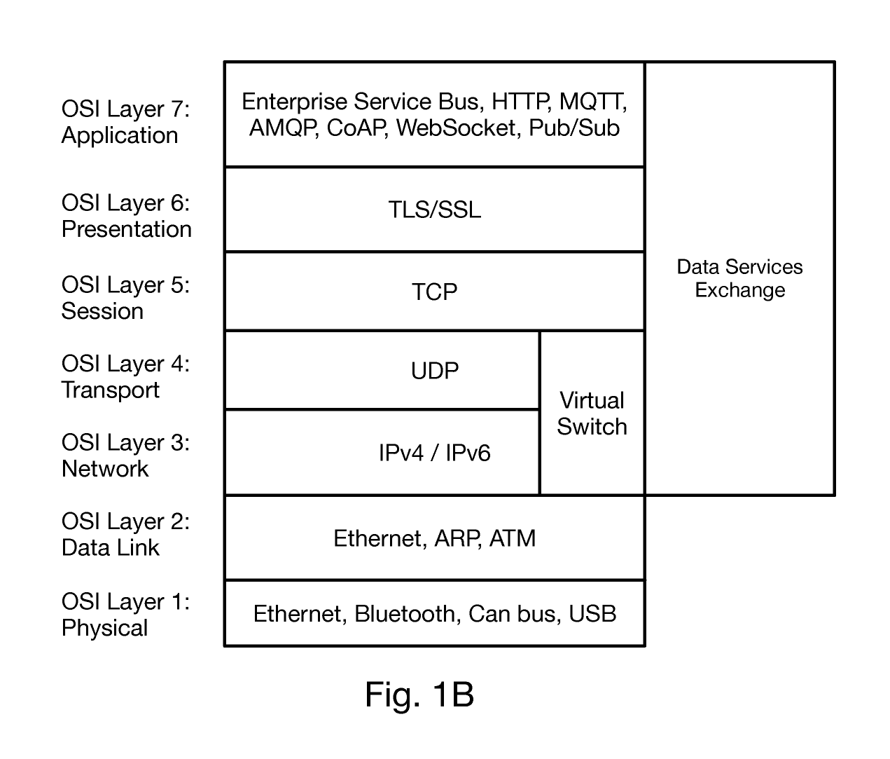

FIG. 1 shows data services exchange (DSE) 100 in bidirectional communication with each of data producer 10, data consumer 20 and third-party application 30. DSE 100 executes third-party application software 101, DSE application software 102 and DSE utility software 103. Consumer 20 executes third-party application software 21. Although only one instance of software programs 21, 30, 101, 102, 103 is shown, it will be understood that there can be multiple instances of each, and they can be different programs. DSE 100 is assumed to be owned by a different entity than the respective owners of producer 10, consumer 20 and third-party application 30; that there can be multiple unrelated instances of each of producer 10, consumer 20 and application 30.

Each of third-party application software 101 and DSE application software 102 functions to process data from IoT devices and/or send control data to IoT devices. Generally, software 101 was developed independently by a third-party who chooses to run it on DSE 100, whereas software 102 was developed especially for DSE 100.

DSE 100 is built to easily allow combinations of data from different sources into new data products through aggregation, filtering and/or intermediate processing by applications referred to as data services. As used herein and in the claims, a “data service” is an application program using data from, or producing data for, the DSE. A data service can be developed for the DSE, or for another environment, and can operate on DSE facilities or on third-party facilities.

In operation, producer 10, such as a sensor farm (collection of sensors) produces data according to its own scheme, such as periodically, in response to a sensed event and/or in response to a control instruction to provide a reading, such as a poll or special request. It will be appreciated that routine sensor readings may be short, primarily indicating no change since the previous reading, whereas exception readings may be longer and include more data than is provided in a routine reading. Producer 10 sends its data to DSE 100 in a format of its choice, typically message-based or streaming.

A data source can provide “data at rest” or “data in motion” or a combination thereof. Data at rest refers to data that has been stored and is typically provided in a message format. Data in motion refers to data that is produced in real time, typically in a streaming format. A data source can provide raw data or processed data. Raw data is unprocessed data. Processed data is data that has been processed, such as by filtering, by transforming or by combining with other data.

Producer 10 may be a conventional data source, such as a stock quote data stream.

DSE 100 receives data from producer 10 and provides the data in real time to selected applications that have requested such data, such as applications 101 and 21. DSE 100 may be configured to store the received data, so it is available for non-real time access by applications, such as applications 102 and 30.

Application programs, such as applications 101, 102, 21 and 30 process the data in some way, often combining the sensor data with other sensor data, then either use the results privately, or provide their processed data to DSE 100 for distribution and/or storage. In some cases, the application programs provide their processed data; in other cases, the application programs provide metadata about their processed data, i.e., metadata indicating the existence and possibly characteristics of the data such as its size and/or cost.

DSE 100 includes utility programs 103 to manage its infrastructure, relieving programs 101, 102 of the need to manage infrastructure. The utility programs serve to schedule other programs, authorize programs to use resources such as real-time distributed data and/or stored data, filter data prior to distributing it, route data, provision DSE 100 such as with more processors or memory, manage provisioned resources such as deleting unused or under-utilized resources, provide a user interface so that humans or programs can query the resources of DSE 100, manage the configuration of DSE 100 such as distributing workload across different data centers, and encapsulate data and functions as appropriate.

Outputs and inputs of each data service are modeled as DSE resources. Outputs are also referred to as data products. DSE resources are each identifiable via a uniform resource identifier (URI). The URI syntax is defined in Internet Engineering Task Force (IETF) Request for Comments (RFC) 3986. Each DSE resource may have multiple uniform resource locators (URLs), see IETF RFC 1738, associated with its URI, providing addressable endpoints of the form:
protocol:[//[user:password@]domain[:port]][/]path[?query][#fragment].

Access control to these DSE resources is usually tied to the contractual relationships between the data producer and the data consumer. Data providers typically have a contractual relationship with DSE 100 specifying usage constraints, if any, for their data. DSE 100 brokers access to data on behalf of the producers, minimizing administrative and contractual overhead to the data producers while enabling the data producers to control who can use their data.

FIG. 2A shows the environment of DSE 100.

DSE 100 is connected to public communication network 5, such as the Internet. DSE 100 may also be connected to private communication networks (not shown), and/or may have local communication not via a network (not shown). DSE 100 is comprised of general purpose computers programmed according to the present invention, along with appropriate storage devices, internal communication capability and administrative terminals. DSE 100 runs on hardware that is rented from a third-party provider, and spans multiple physical locations (not shown), connected to each other via a high-speed internal network and/or via network 5. DSE 100 is assumed to be able to use more or less hardware and other resources as are needed to accommodate its workload, and to automatically obtain resources from, and release resources to, the third-party provider. In some embodiments, DSE 100 runs on dedicated hardware in a third-party data center. In other embodiments, DSE 100 runs in its own private data center.

Data consumer 20 is connected to public communication network 5. Consumer 20 is comprised of suitably programmed general purpose computers and other appropriate resources.

Authentication service 31 functions to authenticate information upon request from DSE 100, and/or to provide authorization for data requests and/or to provide a rights management service. For example, authentication service 31 may make an Oauth2 request, see tools.ietf.org/html/draft-ietf-oauth-v2-31, to an identity provider service such as Facebook or Github to verify credentials in an authorization rule for an operation on specified data. The response from the Oauth2 server is the authorization status of the operation. Authentication service 31 is assumed to be controlled by a third-party, and to operate on suitably programmed general purpose computers and other appropriate resources.

Data producer 10 has three instances, shown as data feed 15, third-party device manager 40 and DSE device manager 50.

Data feed 15 is a conventional source of data, such as securities trading quotes, weather forecasts, news feeds, Twitter, or the like.

Third-party device manager 40 is a suitably programmed general purpose computer, and functions to collect data from devices 11, 12, 13, 14, and send control data thereto. Devices 11, 12, 13, 14 are typically sensors, and may be of the same or different types, such as location sensors, temperature sensors, pressure sensors, moisture sensors, sound sensors and/or cameras for producing images and/or video streams. Devices 11-14 communicate with device manager 40 as appropriate via wireline or wireless communication channels such as low-energy Bluetooth channels. Devices 11-14 are shown in certain communication configurations, but other communication configurations are possible and will be known to those of ordinary skill. Device 11 communicates with third-party gateway 42 that, in turn, communicates with device manager 40. Device 12 communicates directly with device manager 40. Device 13 is a mobile device, and communicates wirelessly with mobile switching center (MSC) 44 that, in turn, communicates with device manager 40; in some embodiments, MSC 44 communicates with device manager 40 via network 5. Device 14 communicates with device manager 40 via network 5. Gateway 42 comprises one or more suitably programmed general purpose computers, and is particularly useful to poll device 11 and pre-process responses from device 11.

DSE device manager 50 is similar to device manager 40, except device manager 50 is controlled by DSE 100, and so may be pre-authorized in certain respects and/or require less authentication. DSE local manager 52 communicates with device manager 50; local manager 52 is generally similar to gateway 42. Devices 16, 17 are generally similar to devices 11-14. Device 16 communicates with local manager 52. Device 17 communicates with device manager 50. Other configurations (not shown) are possible.

DSE 100 pre-integrates multiple device managers so that the data generated by the devices attached to each device manager is available as a data service, identifiable via a URI.

Consumer 54 is a software program that executes on DSE local manager 52. Consumer 54 is an instance of consumer 20 in FIG. 1. Consumer 54 resides on DSE local manager 52 for one or more reasons, such as to reduce the volume of information sent to DSE 100 and/or for enhanced security and/or for enhanced protection against attacks.

Consumer 51 is a software program that is similar to consumer 54, except that consumer 51 executes on DSE device manager 50. Virtual machine 53 is another software program that executes on DSE device manager 50, and functions as an environment for other software programs (not shown) that are instances of programs 101, 102, 103.

An exemplary use of DSE 100 will now be described, wherein a pizza parlor completely outsources its pizza delivery, showing how DSE 100 is useful to owners of autonomous vehicles, couriers responsible for delivering packages, an analytics platform provider, a vehicle tracker platform, a logistics company, a “smart package” manufacturer, and pizza parlors that make pizza. Implementation of this example on DSE 100 is described below with respect to FIG. 10.

Consider getting a pizza from the pizza parlor to the customer's house. Currently, the customer places an order online or via a phone call, and waits 30-40 minutes for a guy with a car to deliver it to the customer's house. The capital expense of owning a car is a barrier to entry to the profession of “pizza delivery guy”. When the customer's pizza arrives it will be of some unknown quality and freshness, and usually requires settlement of payment either through exchange of cash or signing a receipt.

Consider a near future pizza delivery service in which pizza parlors outsource their pizza delivery to freelance couriers who use ride-sharing services to acquire on-demand rides from other people's idle self-driving vehicles. Economically, this makes maximal use of resources while preserving the human touch. The owners of self-driving vehicles contract out their spare capacity to the ride-sharing service in exchange for compensation. The ride-sharing service coordinates the available supply with demand for transport. The analytics platform provider supplies the ride-sharing company with the necessary machine intelligence to predict supply and demand based on data supplied by the vehicle-tracking platform. The vehicle-tracking platform also provides the vehicle owners with a trusted third-party audit of the use of their vehicle by the ride-sharing service. A logistics company may then piggyback on the above data providers to coordinate their smart packages with the freelance couriers who will use the ride-sharing service to deliver the pizzas. The pizza parlor needs only buy the smart packaging from the appropriate logistics company, place the pizza in the package, and it gets delivered to the correct address.

DSE 100 links the disparate services: autonomous vehicles, couriers, ride sharing, logistics, and smart packaging into a functioning system. DSE 100 does this by making information available through context-relative data streams. The information from any one source may be shared and augmented by many different parties based on their contractual relationships. These parties may also offer additional data services or processing to interested third parties using DSE 100 as a broker for settlement. In this example, each of the above parties has a contractual relationship with DSE 100 to broker their information. DSE 100 makes available their data products for a price. DSE 100 takes a commission in exchange for brokering and delivering the data product to the customer. DSE 100 remits the remainder of the sale price to the data product provider.

In this pizza example, each smart package is represented as a DSE resource that makes available the information from the smart package to any interested parties. The cost of this information is included in the price of the packaging, and access to the information could be provided to whoever purchases the object. For example, the smart packaging manufacturer, or its contracting entity, might initially have sole access to the associated DSE resource. When the lot of packages are transferred to the logistics company, access to the DSE resources would be transferred entirely, with the manufacturer no longer retaining any access. The logistics company delivers the smart packages to the pizza parlor, and provide the pizza parlor with access to the DSE resource, but does not transfer ownership. The logistics company does this to ensure it has the capability to deliver the package to its intended recipient, and maintain quality control. Finally, when the pizza parlor sells a pizza to a customer and puts it in the package, the pizza parlor can provide the customer with the information, allowing the customer to track the temperature, moisture content, and location of their pizza, and get notifications of estimated delivery time, such as (i) estimated delivery time as of when the order was placed, (ii) estimated delivery time as of when the pizza is packaged for delivery, (iii) estimated delivery time as of when the pizza was picked up, and (iv) estimated delivery time as of five minutes before arrival of the pizza.

The logistics company may also choose to provide access to a limited fashion to freelance couriers, and potentially augment the data feed with more useful information such as the urgency or any time limits placed on the delivery. The couriers are represented by their own DSE resources to which they can publish information about their location, availability, and desired rates. The logistics companies subscribe to these courier supplied data products to dynamically outsource their delivery. The logistics company may also use third party analytics data services to model the reliability, timeliness, and quality of each courier given ambient conditions such as traffic and weather. This information, too, is brokered through DSE 100 to the ride-sharing company, to help the ride-sharing company predict demand and coordinate availability of vehicles near the couriers.

Each vehicle has telemetry data that it broadcasts to the vehicle-tracking platform, so DSE 100 can also broker this information to interested parties. The vehicle owner may wish to have this information, and make it available to his mechanic and insurance company. The ride-sharing company may be granted access to this information only during the period that the vehicle's owner has determined that the vehicle is available. In this case, DSE 100 provides the contractual access as a broker between the vehicle tracking platform and the ride-sharing company on behalf of the owner of the vehicle and its information.

DSE 100 also coordinates payment between the parties for the information. For example, the ride-sharing company may pay the vehicle owner for access to the vehicle and its information, where at the same time, the owner of the vehicle may pay the vehicle tracking platform monthly for its service. The logistics company pays for the courier's data feed, and pays the ride-share platform for the courier's vehicle usage while contracted. The pizza parlor pays the delivery fees to the logistics company, and receives information about their package through the delivery process for quality control purposes. Finally, the end customer pays for the pizza and receives access to their package's information while in transit. DSE 100 models these contractual relationships and the information exchanged, enabling automated settlement of these exchanges.

FIG. 2B shows the software of DSE 100A, an embodiment of DSE 100.

DSE 100A includes the following programs:
DSE interface 110 serves as a command line interface for DSE 100A;
Reporting service 112 provides usage data aggregation for planning, billing, and failure analysis;
Real-time streaming analytics service 114 provides analysis of component throughput metrics in real time for operations management;
Business rule scripting service 116 provides that ability to automate business use cases in response to system notifications and data streams;
Big data store service 118 provides persistent distributed redundant data storage for other system services and end user applications;
Device management platform 120 provides management capabilities for a collection of devices, and may provide access control and access to device data;
Adapter Framework 122 provides a shared base layer of behavior to all of the protocol and application adapters, primarily concerned with connectivity to data bus 140;
Protocol adapter 124 provides a protocol specific representation of a data stream so that an external application can integrate into the service bus, without being deployed within the same environment as DSE100A;
AMQP adapter 126 is a type of protocol adapter that supports the Advanced Message Queuing (AMQP) protocol;
HTTP adapter 128 is a type of protocol adapter that supports hypertext transfer protocol (HTTP);
WebSocket adapter 130 is a type of protocol adapter that supports the WebSocket protocol providing full-duplex communication channels over a single TCP connection, the WebSocket protocol is defined in Internet Engineering Task Force (IETF) Request for Comments (RFC) RFC 6455;
MQTT adapter 132 is a type of TCP/IP protocol adapter that supports MQ Telemetry Transport, a publish/subscribe lightweight message protocol designed for constrained devices and low-bandwidth, high latency or unreliable networks such as IoT and mobile applications, being standardized with the current specification available at www.ibm.com/developerworks/webservices/library/ws-mqtt/;
CoAP adapter 134 is a type of protocol adapter that supports Constrained Application Protocol (CoAP), a software protocol intended to be used in very simple electronics devices that allows them to communicate interactively over the Internet, particularly targeted for small low power sensors, switches, valves and similar components that need to be controlled or supervised remotely, through standardInternet networks the core CoAP protocol is specified in IETF RFC 7252;
UDP adapter 136 is a type of protocol adapter that supports User Datagram Protocol (UDP) for transmitting connectionless data, see IETF RFC 768;
TCP/IP adapter 138 is a type of protocol adapter that supports Transmission Control Protocol/Internet Protocol (TCP/IP), see IETF RFC 791 (IP), IETF RFC 793 (TCP);
Routing engine and data bus 140 provides high level transport layer services, but DSE 100A assumes it does not control bus hardware, so all messages on the internal bus are encrypted to minimize damage from an intruder;
Third-party application 101 (discussed above) is a third-party application that processes IoT data and/or controls IoT devices;
DSE application 102 (discussed above) is an application developed for DSE 100A to process IoT data and/or control IoT devices;
Administrative API 142 provides a web-based client for a user to manage accounts, security, other users, related user groups, authentication tokens and the like;
Authorization and auth service 144 (“auth service 144”) manages authenticated access controls on data bus resources and negotiates rights management with third-party authorization services;
Cloud management service 146 interfaces with the underlying data center management software to provision virtual or physical machines on behalf of DSE manager 156;
Configuration service 148 manages the configuration of the system over time, and provides DSE manager 156 with a point in time description of the desired arrangement of services;
Dataflow framework 150 is a software abstraction layer that provides a programmatic interface to generating graph descriptions of application data flow.
Dataflow user interface 152 presents the user with a graphical interface describing the flow of data between applications, and provides basic manipulation tools for generating new graphs using the Dataflow Framework 150;
Container service 154 manages Linux Containers on hosts (virtual and physical machines) and provides a container image infrastructure for exchanging containers between hosts;
DSE manager 156 keeps track of the resources currently in DSE 100A and their status; it enforces the configuration policy defined in the Configuration service 148, and notifies the Service Discovery service 162 of desired changes in the environment;
Metering and monitoring service 158 collects and aggregates time series data across the system, and notifies other services of exceptional conditions detected through monitoring
Public key registry 160 stores public keys for programs using DSE 100A, there is one security key per stream/user/time/application;
Service discovery service 162 manages the graph describing the relationships between the components of the system, and evaluates the constraints declared in the graph to generate the system configuration stored in the Configuration service 148;
Models database service 164 provides a time series distributed data model for all of the operational entities in the DSE such as users, accounts, servers, containers, and routes; and
Application adapter 166 provisions data bus resources for an application program, and manages connectivity between the application and the data bus. A “container” is a software program that runs in an isolated user space process group on top of an operating system's kernel, allowing multiple isolated user space instances to run on a single host. The containerization process encapsulates runtime state, and provides a well-defined configuration application programming interface (API) that is managed by modifying the process environment. In contrast, a virtual machine runs on physical hardware via an intermediation layer; a VM is often a full instance of a Linux kernel running inside of another Linux kernel. Containers are considered lightweight, relative to VMs. Container services include Docker, OpenVZ, Solaris Zones, and Linux lxc. Docker is an open-source program that automates the deployment of applications into containers, comprising an application deployment program and a virtualized container execution environment. Docker is described in The Docker Book, Turnbull, available at dockerbook.com. Docker is available at www.docker.com.

FIG. 2C is a diagram showing a partial view of the configuration in DSE 100A, including the hardware and software components configured to expose data in disparate formats for use by other programs.

Routing Engine and Data Bus 140 of FIG. 2B is shown in FIG. 2C as routing engine 140A, external bus 140B and internal bus 140C. It will be understood that each of external bus 140B and internal bus 140C can be implemented as a plurality of data buses, possibly spanning different physical locations, in which case a gateway (not shown) is provided at each of the physical locations so that the buses at different locations operate together. Each of external bus 140B and internal bus 140C functions to transmit data in both of message format and streaming format, as appropriate for the specific data. One advantage of multiple buses is improved security by separating external network traffic from internal traffic. Another advantage of multiple buses is that resources can be scaled independently to accommodate usage. Typically, an external bus uses more caching and handles more point-to-point traffic, while an internal bus used more broadcast and multicast traffic with low latency.

In some embodiments, external bus 140B and internal bus 140C are combined into one data bus.

In this embodiment, DSE 100A executes on third-party computing hardware from a managed cloud computing provider such as Rackspace US, Inc., see www.rackspace.com. In other embodiments, DSE 100A executes on private computing hardware. The computing hardware includes general purpose server computers, communication facilities and data storage facilities. In still other embodiments, DSE 100A executes on an IoT platform provided by a third-party.

At DSE 100A, external bus 140B communicates with entities external to DSE 100A, including data feed 15, third-party device management platform 40, DSE device management platform 50 executing DSE application 55, consumer 20 executing third-party application 21, and authentication service 31, and with programs internal to DSE 100A, including secure socket proxies 90A, 90B, 90C, caching reverse proxies 91A, 91B, 91C, and application adapters 166A, 166B. Internal bus 140C communicates only with programs and devices internal to DSE 100A, including the programs that communicate on external bus 140B, data storage 90, protocol adapters 124A, 124B, 124C, DSE application 102, auth service 144, and routing engine 140A. Although FIG. 2C shows only a few instances of programs internal to DSE 100A, in practice there are up to millions of simultaneously executing programs. Protocol adapters and application adapters are instances of data bus broker programs. The operation of these programs is discussed in detail below.

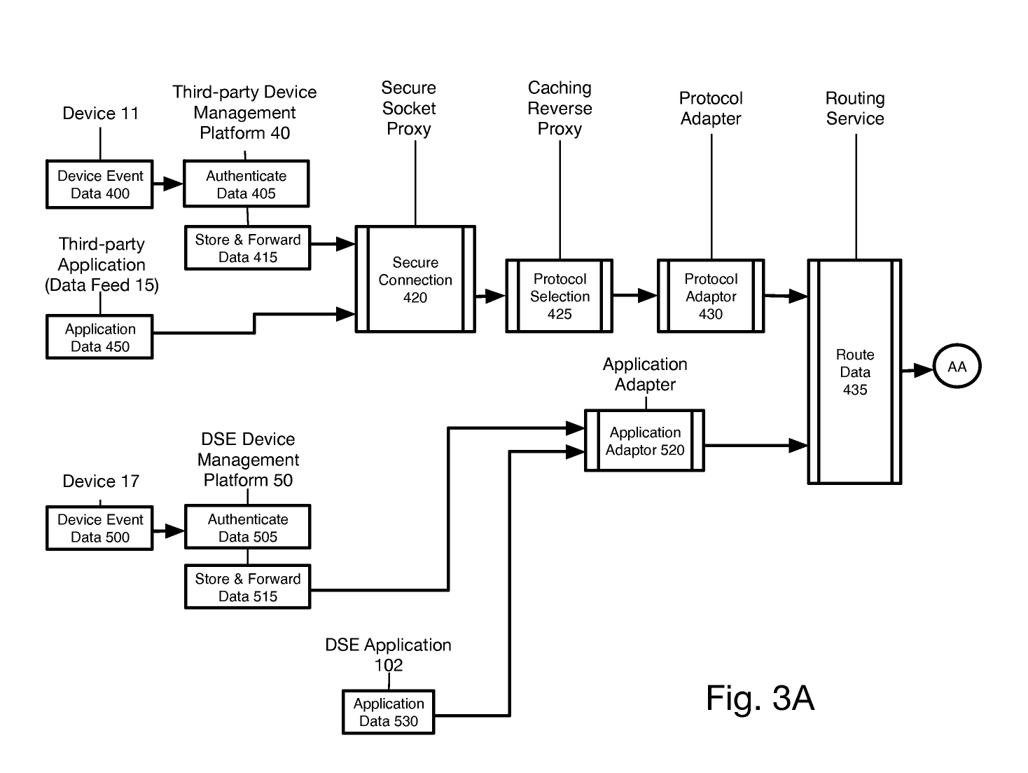

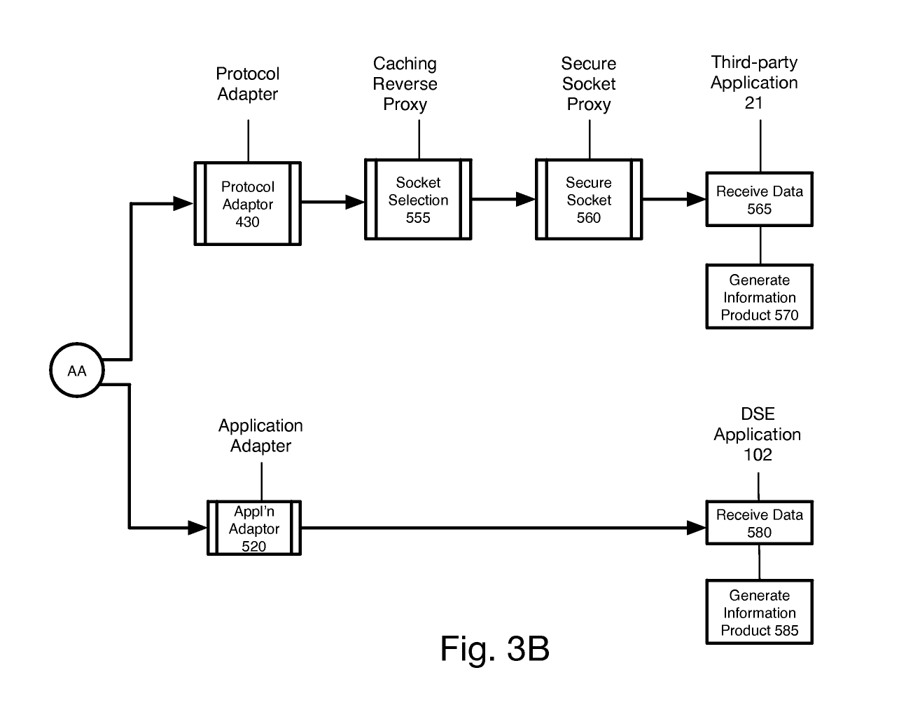

FIGS. 3A-3B are charts showing how information travels in the data services exchange.

FIG. 3A shows that data arrives at DSE 100A, is extracted for transmission on data bus 140C, and is routed. FIG. 3B shows that the extracted data is then encapsulated in accordance with the needs of the data recipient. The extraction and encapsulation are done by a protocol adapters for data from an entity configured by a third-party, or by application adapters for data from a DSE-configured entity; as required, the extraction is done by one of a protocol adapter and an application adapter, while the encapsulation is done by one of a protocol adapter and an application adapter, probably with different protocols for the incoming and outgoing data. The extraction exposes the data as a resource having its own universal resource identifier (URI) so the data resource can be used by different data consumers.

A consumer needs to know a URL associated with the URI for the resource, and then can immediately start using it with a suitable protocol adapter or application adapter for encapsulation. In turn, a data consumer can produce a data resource with its own URI that can be used, via URLs, by other data consumers. Configuring data as a URL-addressable resource provides tremendous flexibility, and avoids conventional difficulties that arise when data is in a relational database, and a consumer wants the data in a manner than is inconsistent with the underlying relational data model. Configuring data as a URL-addressable resource simplifies life for a data consumer relative to a conventional relational database, as the consumer does not need to understand the relational data model. Software developers are familiar with URIs and URLs, and modern computer languages have software libraries supporting URI usage and parsing. The URI scheme enables representing the identity of the identified object across media, such as both software and paper documents, reducing the difficulty of documenting contractual relationship with respect to the URI-identified data products.

FIG. 3A shows four exemplary configurations for incoming data; other configurations will be apparent to those of ordinary skill in the art. As used herein and in the claims, “incoming data” means data that is to be available to at least one consumer of data that uses DSE 100A.

In a first incoming configuration, device 11, shown in FIG. 2A, produces data in message or streaming format, and provides its data to third-party device management platform 40, shown in FIGS. 2A and 2C. Platform 40 authenticates the data at step 405 using a suitable authentication technique, may store the data, and at step 415, forwards the data to DSE 100A. The data may be provided in real-time, such as event-driven data, or may be provided on a message-basis, such as polled data.

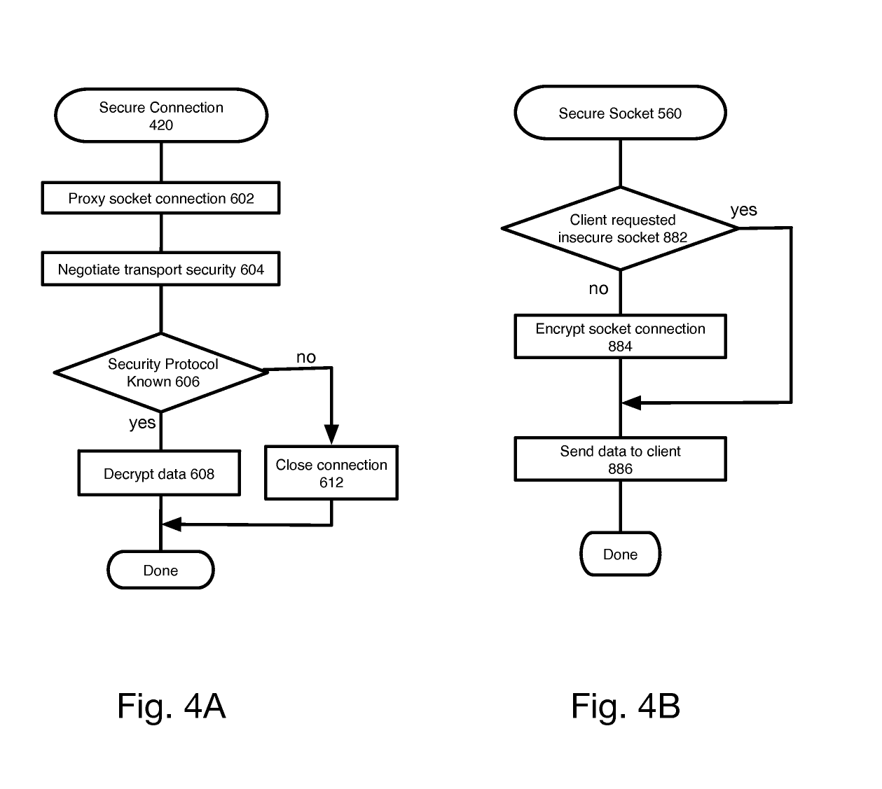

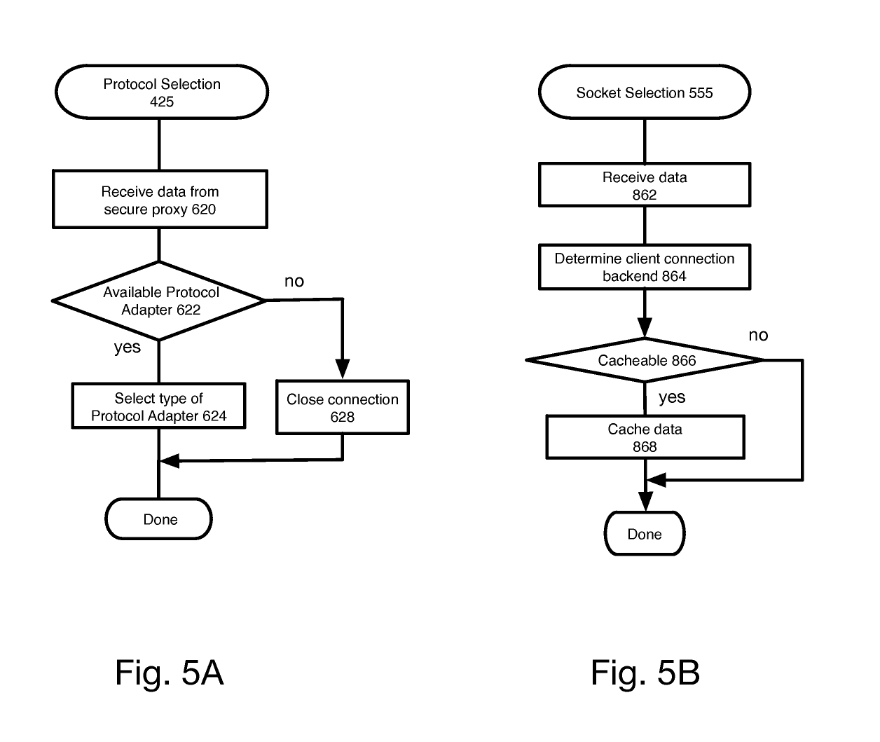

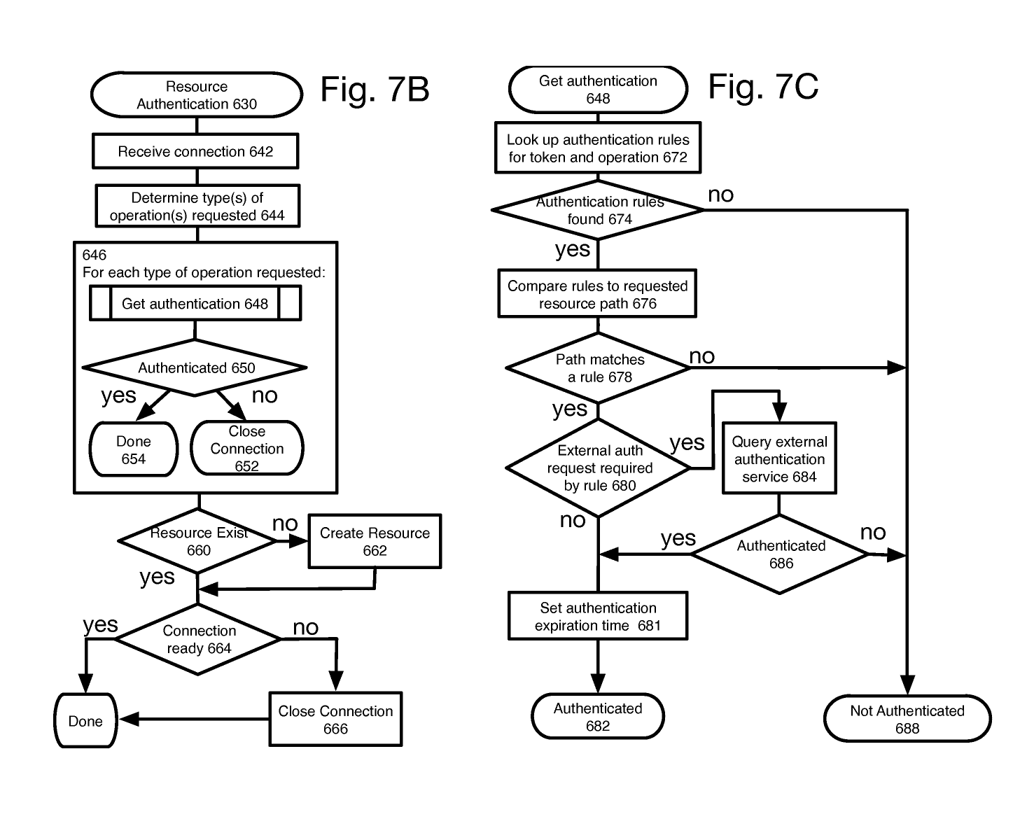

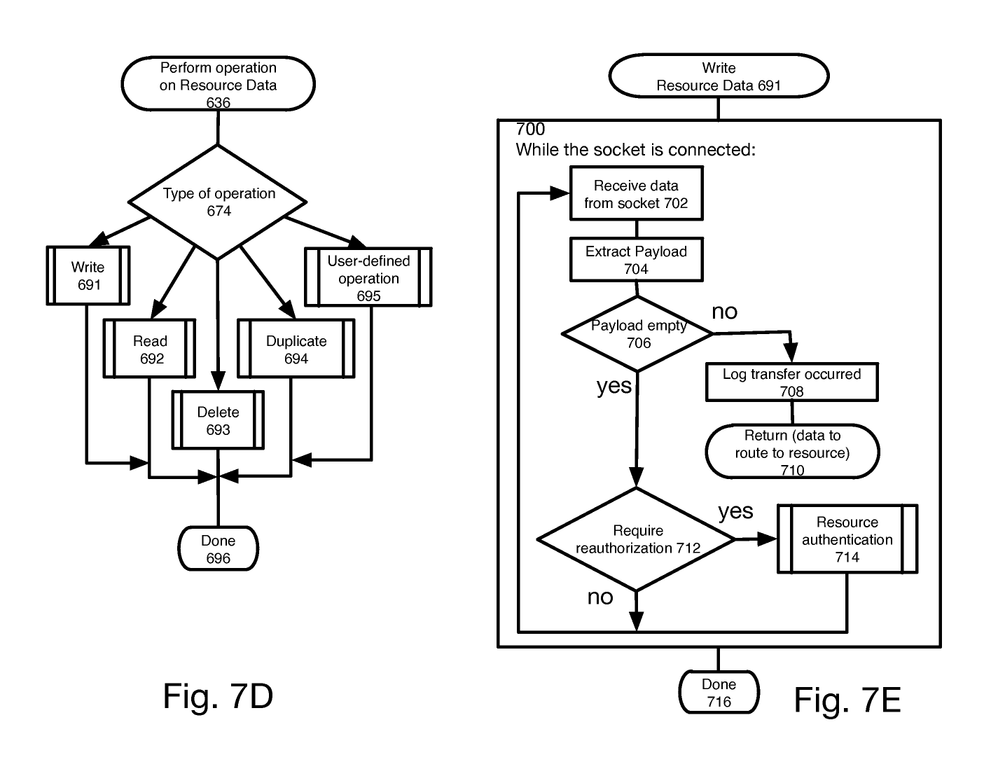

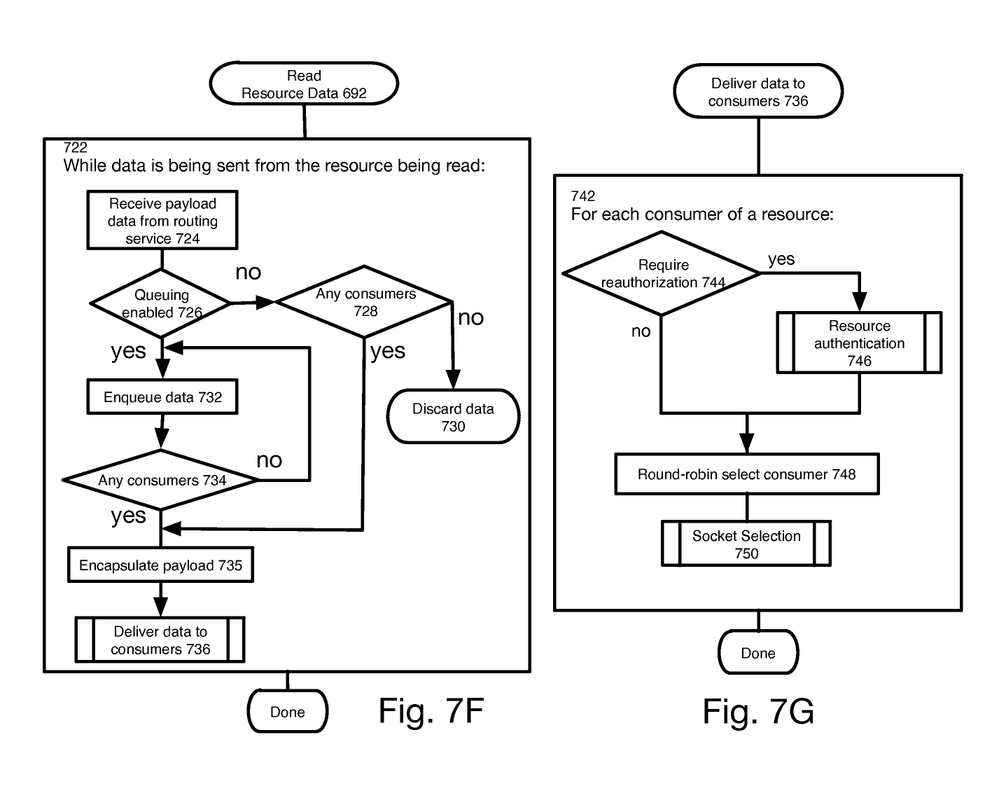

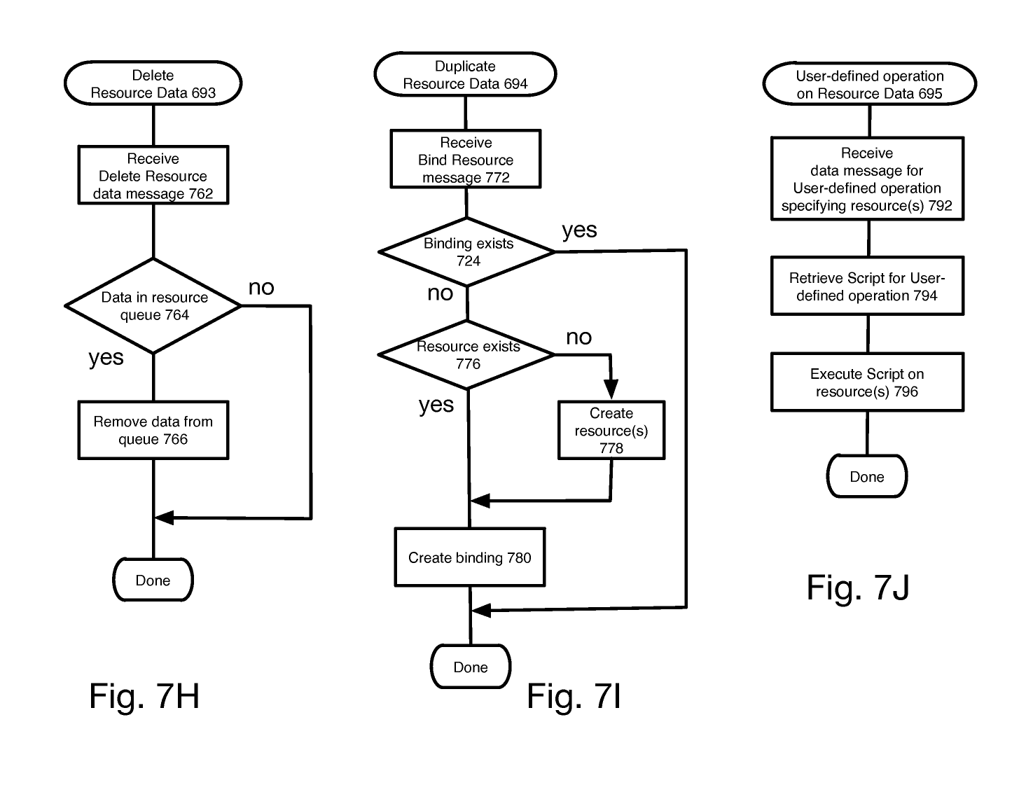

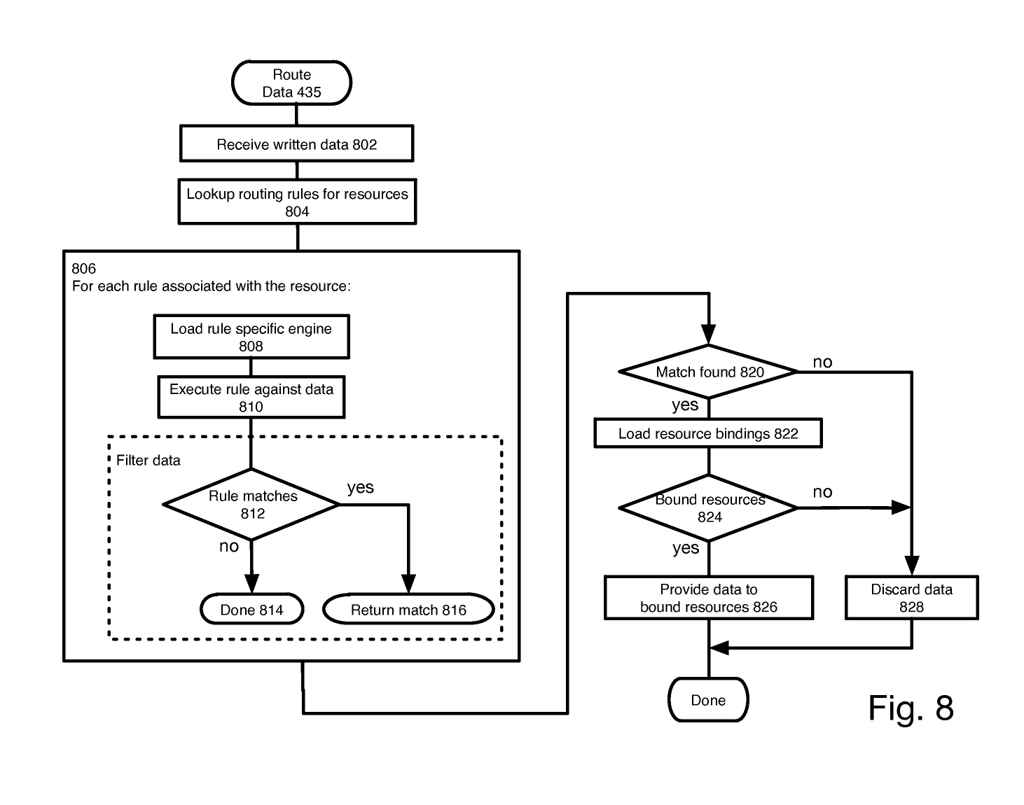

At DSE 100A, the data from platform 40 is provided to secure socket proxy 90A, shown in FIG. 2C, the operation of which is shown in FIG. 4A, and then to caching reverse proxy 91A, shown in FIG. 2C, the operation of which is shown in FIG. 5A, then to protocol adapter 124A, shown in FIG. 2C, the operation of which is shown in FIGS. 7A-7J, then to routing engine service 140A, shown in FIG. 2C, the operation of which is shown in FIG. 8.

In a second incoming configuration, data feed 15, shown in FIG. 2A, produces data in message or streaming format, and provides its data to DSE 100A. The data may be provided in real-time, such as event-driven data, or may be provided on a message-basis, such as polled data.

At DSE 100A, the data from data feed 15 is provided to secure socket proxy 90B, shown in FIG. 2C, the operation of which is shown in FIG. 4A, and then to caching reverse proxy 91B, shown in FIG. 2C, the operation of which is shown in FIG. 5A, then to protocol adapter 124B, shown in FIG. 2C, the operation of which is shown in FIGS. 7A-7J, then to routing engine service 140A, shown in FIG. 2C, the operation of which is shown in FIG. 8.

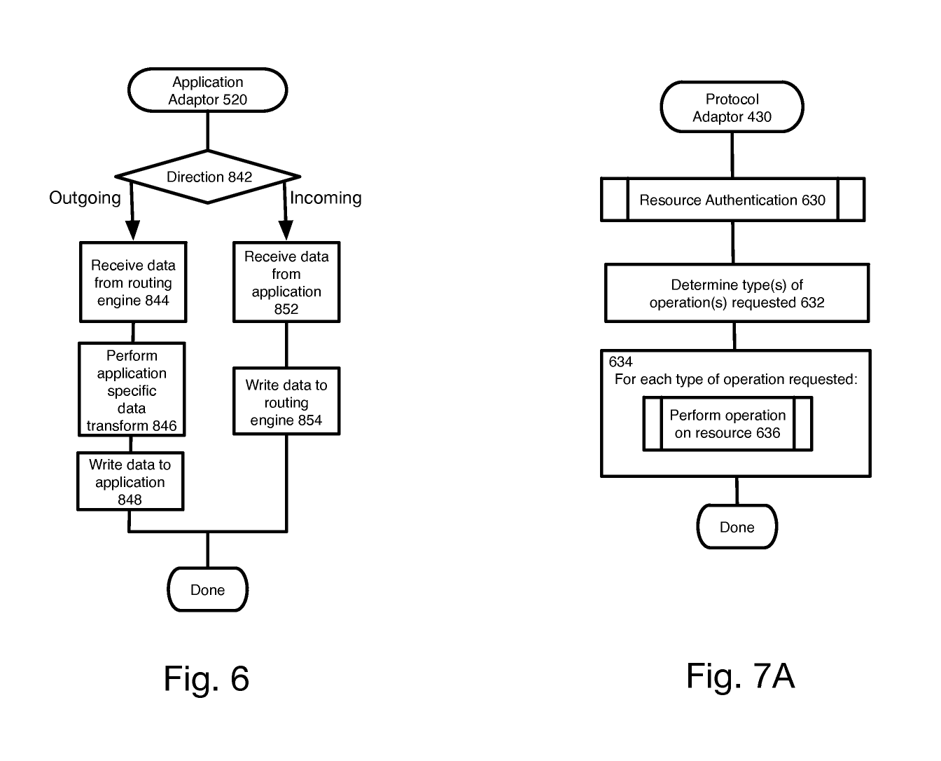

In a third incoming configuration, device 17, shown in FIG. 2A, produces data in message or streaming format, and provides its data to DSE device management platform 50, shown in FIGS. 2A and 2C. Platform 50 authenticates the data at step 505 using a suitable authentication technique, may store the data, and at step 515, forwards the data to application adapter 166A, the operation of which is shown in FIG. 6, then to routing engine service 140A, shown in FIG. 2C, the operation of which is shown in FIG. 8.

In a fourth incoming configuration, data is produced by DSE application 102, shown in FIGS. 2A, 2B, 2C. DSE application 102 is already at DSE 100A. As discussed in FIG. 3C, DSE application 102 is also a consumer of data from entities other than itself.

FIG. 3B shows two exemplary configurations for outgoing data; other configurations will be apparent to those of ordinary skill in the art. As used herein and in the claims, “outgoing data” means data that being used by at least one consumer of data that uses DSE 100A.

In a first outgoing configuration, data from routing engine service 140A, shown in FIG. 2C, is provided to protocol adapter 124C, shown in FIG. 2C, the operation of which is shown in FIGS. 7A-7J, then to caching reverse proxy 95C, the operation of which is shown in FIG. 5B, then to secure socket proxy 90C, the operation of which is shown in FIG. 4B, then to third-party application 21, shown in FIG. 2A and 2C, which receives the data at step 565, uses it for its own private purposes, and may, at step 570, generate an information product based on the received data that is made available to data consumers using DSE 100A.

In a second outgoing configuration, data from routing engine service 140A, shown in FIG. 2C, is provided to application adapter 166B, shown in FIG. 2C, the operation of which is shown in FIG. 6, then to DSE application 102, shown in FIGS. 2A, 2B, 2C, which receives the data at step 580, uses it for its own private purposes, and may, at step 585, generate an information product based on the received data that is made available to data consumers using DSE 100A, as shown in FIG. 3A.

Operation of the elements of FIGS. 3A-3B will now be discussed.

FIGS. 4A-4B are flowcharts respectively showing incoming and outgoing traffic operation of a secure socket proxy program in DSE 100A, such as secure socket proxy 90A, 90B, 90C shown in FIG. 2C. Non-DSE programs always access DSE 100A via a secure socket proxy.

A socket is an addressable endpoint of an inter-process communication across a computer network. Secure socket proxy 90A functions to provide secure transmission of socket data.

For incoming traffic, as shown in FIG. 4A, at step 602, proxy 90A establishes a proxy connection, according to a suitable standard such as IPv4 or IPv6. At step 604, proxy 90A negotiates transport security, such as TLS. At step 606, proxy 90A determines whether the security protocol that the sender is trying to use is supported by proxy 90A. DSE 100A supports various protocols such as hypertext transfer protocol (HTTP), WebSocket, TCP, UDP, MQTT, AMQP, mentioned above with respect to FIG. 2B. If so, then at step 608, proxy 90A decrypts the incoming data. If not, at step 612, proxy 90A closes the connection, thereby refusing to receive the data. Processing of incoming data by proxy 90A is now complete.

For outgoing traffic, as shown in FIG. 4B, at step 882, proxy 90A checks whether the sender of data requested an insecure socket, such as by connecting without TLS enabled. If so, processing continues at step 886 without encryption. If not, at step 884, proxy 90A encrypts the outgoing data. At step 886, proxy 90A sends the outgoing data to the recipient. Processing of outgoing data by proxy 90A is now complete.

FIGS. 5A-5B are flowcharts showing incoming and outgoing traffic operation of a caching reverse proxy program in DSE 100A, such as caching reverse proxy 91A, 91B, 91C shown in FIG. 2C.

A reverse proxy is a type of proxy server that retrieves resources on behalf of a client from one or more servers, improving security and load balancing, the resources being returned to the client as though they originated from the reverse proxy. A reverse proxy acts as an intermediary for its associated servers to be contacted by any client, in contrast to a forward proxy that acts as an intermediary for a client to contact any server. A caching reverse proxy has the ability to store data. Caching reverse proxy 91A functions to represent DSE 100A to the client.

For incoming traffic, as shown in FIG. 5A, at step 620, caching reverse proxy 91A receives data from secure socket proxy 90A. At step 622, proxy 91A checks whether there is an available protocol adapter for the received data. DSE 100A maintains a list of all protocol adapters, such as in data storage 90, and periodically tests the operating capacity of each protocol adapter. If no protocol adapter is available, then at step 628, proxy 91A closes the connection, thereby refusing to receive the incoming data. If a protocol adapter is available, then at step 624, proxy 91A selects the type of protocol adapter, determined by the protocol identified in the incoming data. Processing of incoming data by proxy 91A is now complete.

For outgoing traffic, as shown in FIG. 5B, at step 862, caching reverse proxy 91C receives the outgoing data from protocol adapter 124C, which may correspond to the incoming data from protocol adapter 124A. At step 864, proxy 91C selects the client connection backend, such as secure socket proxy 90C, using a dynamic routing table residing in memory in caching reverse proxy 91C. At step 866, proxy 91C determines if the outgoing data is cacheable by comparing the outgoing route for the resource against a list of cacheable resources retrieved from data storage 90. If not, processing is complete. If the data is cacheable, at step 868, proxy 91C caches the outgoing data for access by future requests to the same resource by secure socket proxy 90C while the authorization access for the cached data is unexpired, i.e., its time-to-live is greater than zero. Processing of outgoing data by proxy 91C is now complete.

FIG. 6 is a flowchart showing incoming and outgoing traffic operation of an application adapter program in DSE 100A, such as application adapter 166A, 166B shown in FIG. 2C.

An application adapter is specific to an application programming interface (API) for a particular application program or DSE interface. Application adapter 166A creates a resource, typically delivering its output as raw messages or a raw data stream devoid of protocol metadata. Application adapter 166A omits authenticating received data because it runs within a trusted context on internal bus 140C. In contrast, external applications requesting resource access undergo authorization checking Application adapters that interface to third-party SaaS platforms negotiate authorization on a per-connection basis defined by the SaaS platform.

At step 842, adapter 166A determines whether the data is incoming or outgoing.

For incoming data, at step 852, adapter 166A receives data from a file socket protocol of an application hosted external to DSE 100A, and providing data in a protocol chosen by the application. At step 854, adapter 166A writes the received data to routing engine 140A. Processing of incoming data by adapter 166A is now complete.

For outgoing data, at step 844, adapter 166A receives data from routing engine 140A. At step 846, adapter 166A encapsulates the data as required by the recipient application, such as creating an HTTP request or generating an SQL query. At step 848, adapter 166A writes the transformed data to the file socket application programming interface (API) of the recipient. Processing of outgoing data by adapter 166A is now complete.

FIGS. 7A-7J are a flowchart showing operation of a protocol adapter program in DSE 100A, such as protocol adapter 124A, 124B, 124C shown in FIG. 2C.

A DSE 100A protocol extracts data for transmission on data bus 140C, shown in FIG. 2C, and encapsulates data received from bus 140C. In contrast to a canonical bus format used on a conventional enterprise service bus where all data on the bus is in the same format, the protocol adapter does not provide an envelope for the data, routing engine 140A does not transform the data, and bus 140C routes raw data. An advantage of not using a canonical data format is the ability to support a wider range of applications. For example, DSE 100A can extract the payload data from SMS messages, JSON documents, MPEG4 video, PCM audio and speech-to-text transcripts, then provide the payload data to a data consumer for combination into a new data product such as a data stream having video, audio and data channels, and encapsulation into MPEG TS protocol. Conventional PaaS systems are unable to do this.

At step 630, protocol adapter 124A asks auth service 144, shown in FIGS. 2B and 2C, to authenticate the data resource, regardless of whether it is incoming or outgoing data. See FIG. 7B. After authentication succeeds, at step 632, protocol adapter 124A determines the type of operation(s) requested by examining the metadata, if any, in the originating request and matching the metadata with a protocol specific mapping to DSE resource operations. At step 634, for each type of operation requested, at step 636, protocol adapter 124A performs the requested operation on the resource. See FIG. 7D. Processing of data by protocol adapter 124A is now complete.

Turning to FIG. 7B, at step 642, auth service 144 receives an authentication request from protocol adapter 124A. At step 644, auth service 144 determines the type of operation(s) requested in similar manner as at step 632. At step 646, for each type of operation requested, auth service 144 gets authentication for the operation, see FIG. 7C. If the authentication succeeds, at step 654, auth service 144 goes on to the next operation, if any. If the authentication fails, at step 652, auth service 144 closes the connection, asymmetrically disconnecting the unauthorized application from DSE 100A and preventing further access from that connection to help block a denial-of-service attack, or similar. After all requested operations have been evaluated, processing continues at step 660.

Turning to FIG. 7C, auth service 144 retrieves the authorization rules for the token and requested operation from data storage 90. A resource authorization rule is typically a regular expression—a sequence of characters that define a search pattern—that matches against a single resource URI or a related family of resource URLs to provide access for a single operation on the resource. An authorization rule may also include meta-data and/or software procedures used for authorization by/with authentication service 31. The token was provisioned previously via DSE interface 110 as a shared secret. At step 674, auth service 144 checks whether any authorization rules were retrieved. If not, at step 688, auth service 144 determines that the operation is not authorized, and the authentication process fails.

If at least one authorization rule was retrieved at step 672, then at step 676, auth service 144 compares the rule(s) to the requested resource path. An example of an authentication rule is:
{“operation”: “write”, “path”: “/meters.\.*/” , “token”: “meter-readers”}
   If the requested resource path does not match any rule, processing continues at step 688, discussed above.

If the requested resource path matches at least one retrieved rule, then at step 680, auth service 144 determines whether the rule requires use of an external authentication service, and if so, which external authentication service, and processing continues at step 684. If external authentication is not required, then the fact that the requested resource path matches a retrieved rule serves as authentication, so at step 681, auth service 144 sets an authentication duration for the authentication event, by setting an authentication timestamp and a time-to-live (TTL) measured relative to the authentication timestamp, and at step 682, the requested operation is determined to be authenticated.

If external authentication is required, then at step 684, auth service 144 sends an authentication query to authentication service 31, shown in FIGS. 2A and 2C, and receives a response. If the response is that the requested resource path was not authenticated, processing continues at step 688, discussed above. If the response is that the requested resource path was authenticated, processing continues at step 681, discussed above.

Returning to FIG. 7B, at step 660, auth service 144 determines if the requested resource exists. If not, at step 662, auth service 144 asks routing engine 140A to create the resource. In response to the request for resource creation, routing engine 140A allocates the necessary resources to model the requested resource. In turn, modeling the resource results in creation of the resource by generating a URI, and the necessary system resources will then be allocated on-demand. At step 664, assured that the resource exists, auth service 144 checks that the connection is ready. A connection may have timed-out during authorization negotiation or been disconnected by network failure. If the connection is not ready, then at step 666, auth service 144 closes the connection, which is equivalent to failing to authenticate the requested operation(s). If the connection is ready, then auth service 144 finishes processing, which is equivalent to authenticating the requested operation(s) for protocol adapter 124A.

Turning to FIG. 7D, at step 674, protocol adapter 124A determines which software module to load and execute from data storage 90 based on the operation(s) requested. If the requested operation is a write operation, at step 691, a write module is loaded by protocol adapter 124A and performs the write operation, see FIG. 7E. If the requested operation is a read operation, at step 692, a read module is loaded by protocol adapter 124A and performs the read operation, see FIG. 7F. If the requested operation is a delete operation, at step 693, a delete module is loaded by protocol adapter 124A and performs the delete operation, see FIG. 7H. If the requested operation is a duplicate operation, at step 694, a duplicate module is loaded by protocol adapter 124A and performs the duplicate operation, see FIG. 7I. If the requested operation is any other operation, at step 695, protocol adapter 124A searches data storage 90 for an appropriate user-defined module, loads the module and performs the user-defined operation, see FIG. 7J.

Turning to FIG. 7E, for a write operation, protocol adapter 124A performs step 700 while the socket from the data provider is connected. At step 704, protocol adapter 124A receives data from caching reverse proxy 91A. At step 704, protocol adapter 124A extracts the payload from the received data according to the rules of the protocol that protocol adapter 124A is adapted for; separating the payload data from the protocol-specific data. As used herein and in the claims, “payload” means data exclusive of protocol-related metadata. At step 706, protocol adapter 124A checks whether there was any payload data. If there was payload data, at step 708, protocol adapter 124A prepares a log entry that the data transfer occurs and writes the log entry to an audit file in data storage 90, and at step 710, returns the payload data so that it can be routed by routing engine 140A, discussed below with respect to FIG. 8. If there was no payload data, at step 712, protocol adapter 124A determines whether reauthorization is required by checking the time-to-live (TTL) on the response to the authorization request at step 682 of FIG. 7C. If the authorization response has expired, i.e., more time has passed that the value of TTL, then reauthorization is required. If reauthorization is not required, processing returns to step 702. If reauthorization is required, at step 714, protocol adapter 124A asks auth service 144 to authenticate the on-going write operation, see FIG. 7B, and then processing returns to step 702.

Turning to FIG. 7F, for a read operation, protocol adapter 124C performs step 722 while data is being sent from the resource being read, generally a data producer or a stored data. The resource being read is generally unaware of which, if any, data consumers are reading its data. A read operation is assumed to be “outgoing” in that it can only be performed on data available at DSE 100A, availability being due to either storage in data storage 90 or to real-time reception from the data producer; the consumer and producer of the data can each be internal or external to DSE 100A.

At step 724, protocol adapter 124C receives the data being read from routing service 140A. At step 726, protocol adapter 124C determines if queuing is enabled for the reader of the data by checking the runtime configuration file of protocol adapter 124C. If not, at step 728, protocol adapter 124C checks whether there are any consumers for the data. A connection can be terminated intentionally by the consumer, by a time-out, by a network failure, or in another manner. If there are no consumers, at step 730, protocol adapter 124C discards the data. If there is at least one consumer for the data, processing continues at step 735. If queuing is enabled, then at step 732, protocol adapter 124C enqueues the data in a buffer associated with the data producer for a first time duration. At step 734, protocol adapter 124C checks whether there are any consumers for the data. If there are no consumers, processing returns to step 732 and the data is queued for a second time duration smaller than the first time duration. When there is at least one consumer for the data, at step 735, protocol adapter 124C encapsulates the data according to the protocol it implements, and at step 736, protocol adapter 124C delivers the data to the consumer(s), see FIG. 7G.

Turning to FIG. 7G, to deliver data to a consumer/reader of a resource, protocol adapter 124C performs step 742 for each consumer identified at steps 728 and 734 of FIG. 7F. Step 742 comprises multiple steps that will now be discussed.

At step 744, protocol adapter 124C determines whether reauthorization is required by checking whether the authorization has expired. If reauthorization is required, at step 746, protocol adapter 124C asks auth service 144 to authenticate the on-going read operation, see FIG. 7B. At step 748, protocol adapter 124C selects a consumer of the data, such as by a round-robin procedure. At step 750, protocol adapter 124C transfers the data being read for the selected consumer to caching reverse proxy 91C, see FIG. 5B.

Turning to FIG. 7H, for a delete operation, at step 762, protocol adapter 124A receives an instruction to delete resource data. Delete Resource Data is a distributed operation wherein each protocol adapter or application adapter that performs queuing receives an instruction to purge specified data from their queues from routing engine 140A via a message on data bus 140C. At step 764, protocol adapter 124A checks whether there is data in its queue associated with the resource identified in the instruction from routing engine 140A. If not, processing is complete. If there is data, at step 766, protocol adapter 124A deletes the data from its queue.

Turning to FIG. 7I, for a duplicate operation, at step 772, protocol adapter 124A receives a Bind Resource instruction from an application to bind a source resource to a destination resource with a corresponding routing rule or function that evaluates to a Boolean value. In DSE 100A, duplicating a resource occurs by “binding” the source resource to one or more destination resources. Binding a resource creates the newly-bound resource as either source or destination, and creates the routing rule or function. Data from the source resource is forwarded to the destination resource if and only if the associated rule evaluates as true for the data. Routing rules are discussed below with respect to FIG. 8. Binding is typically used for content filtering. Multiple bindings can be used to aggregate data from respective source resources to a single destination resource. Alternatively, multiple bindings can be used to partition data from a source resource, with different routings, so that respective destination resources receive only respectively selected portions of source data. The URI format for a binding takes the form:
dse:/<source resource path>/<destination resource path>/<pattern or function>

Example of resource bindings are:
All telemetry data from vehicles goes to the tracking platform:
   dse:/telemetry/tracking in/.*
Usage data from vehicle 123 goes to owner.123's cellphone:
   dse:/usage/owner.123/vehicle.123
Owner 123's availability calendar is made available to both the Ride Sharing platform and Analytics platform:
   dselavailability/rideshare.in/owner.123
   dselavailability/analytics.in/owner.123

At step 724, protocol adapter 124A checks whether a binding for the resource to the named entity already exists by querying the routing table API of routing engine 140A; if so, nothing needs to be done and processing is complete. If a binding for the resource to the named entity does not exist, then at step 776, protocol adapter 124A checks whether the resource exists. If the resource does not exist, then at step 778, protocol adapter 124A instructs routing engine 140A to create the resource and add the newly-created resource to the routing table maintained by routing engine 140A. At step 780, assured that the resource exists, protocol adapter 124A creates a binding for the named resource to the named entity by submitting a “bind” request to routing engine 140A.

Turning to FIG. 7J, for a user-defined operation, at step 792, protocol adapter 124A receives an instruction identifying a user-defined operation that is to be performed on a specified resource(s). User-defined operations enable a user to exploit protocol specific capabilities such as protocol extensions or proprietary interpretations of protocol-dependent user metadata, by providing at run-time, new behavior for the protocol adapter. The user-defined behaviors are checked at run-time by authentication service 122, limiting their access if necessary. At step 794, protocol adapter 124A retrieves the script for the user-defined operation from data storage 90. The script is written in a limited programming language such as Javascript running in a sandbox environment, and was previously created by a human programmer, or on behalf of, a data consumer. At step 796, protocol adapter 124A instructs the sandboxed interpreter to execute the script on the data identified as an argument of the user-defined operation. An example of a user-defined operation is:
//allow the client to change the connection timeout by sending

//a {“timeout”:<delay in ms>} message to the protocol adapter
//requires a permission “set_timeout” on a path
function set_timeout (x) {this.timeout=x.timeout;}

FIG. 8 is a flowchart showing operation of routing engine 140A in DSE 100A.

At step 802, routing engine 140A receives data, which can be incoming or outgoing. At step 804, routing engine 140A retrieves the routing rules for the data from data storage 90. The routing rules were established when applications or users made requests via protocol adapters, as described above with respect to FIG. 7I. A routing rule can be based on metadata, on pattern matching, or on a script.

An example of a metadata-based routing rule is:
mpeg.us.ny.*

An example of a pattern match routing rule is:
/“channel_id”:(\d+)/

An example of a script based routing rule is:
function (x) {return x.temp>32 and x.temp<100}

At step 806, for each rule associated with the resource, routing engine 140A loads a rule engine software module associated with the rule type from data storage 90. Rules engine modules are generally developed especially for DSE 100A and include but are not limited to:
metadata regular expression match,
metadata script such as javascript,
metadata structural pattern match,
metadata literal match,
metadata boolean logic match,
metadata full text search match,
content based regular expression match,
content based script match, such as javascript,
content based structural pattern match,
content based boolean logic match, and
content based full text search.

At step 810, routing engine 140A executes the rule against the data received at step 802. At step 812, routing engine 140A checks whether the rule matches the received data. If not, at step 814, processing of this rule is complete and routing engine 140A goes on to the next rule, if any. If there is a match, then at step 816, routing engine 140A saves the match and goes on to the next rule, if any. Steps 812, 814, 816 are sometimes referred to as filtering the data.

After all rules have been evaluated, at step 820, routing engine 140A checks whether any matches were found at step 816. If not, at step 828, routing engine 140A discards the data, and processing of the data is complete.

If at least one rule matching the data has been found, at step 822, routing engine 140A loads a resource binding for each rule from data storage 90 to discover the URL(s) of the destination resources. At step 824, routing engine 140A checks whether there are any bound resources, that is, whether there are any destination resources to which this data should be forwarded. If not, processing continues at step 828, discussed above. If there are bound resources, then at step 826, routing engine 140A provides the data to the bound resources by sending the data via bus 140C to the protocol adapters and/or application adapters respectively bound to the destination resources, and processing is complete.

A usage example will now be discussed. Assume that, in FIG. 2A, devices 11-13 are sensors, and that consumer 20 and DSE application 102 create respective data products based on the data from temperature sensor 12.

Assume that temperature sensor 12 provides a temperature reading to device management platform 40 every ten minutes, and that device management platform 40 provides sensor readings to DSE 100 if the temperature reading is under 40 degrees or over 80 degrees. Assume that on Sep. 25, 2015, sensor 12 provided a temperature reading of 83 degrees, and platform 40 forwarded this reading to DSE 100 at time 10:30:59 (hours:minutes:seconds). Data from platform 40 goes to secure socket proxy 90A, then to caching reverse proxy 91A, then to protocol adapter 124A in the form:
WRITE<source>sensor12, <date>2015sep25, <time>10:30:59, <value>83

At FIG. 7A step 630, protocol adapter 124A authenticates the received data. At FIG. 7B, step 648, protocol adapter asks auth service 144 to authenticate the data. At FIG. 7C step 672, auth service 144 gets the authorization rule for the WRITE operation:
{“operation”:“write”,“path”:“/meters.\.*/”, “token”:“meter-readers”}
   At step 676, auth service 144 compares the rule to the requested resource path as determined in the URI scheme Since there was a match, at step 681, auth service 144 sets a time-to-live value of 20 seconds, and returns an authentication:
{“auth”:true}
   At FIG. 7A step 634, protocol adapter 124A writes the data to routing engine 140A.

Assume that, at FIG. 8 step 802, routing engine 140A receives data from protocol adapter 124A, identified by the URI:
dse:/platform40/sensor12
   The URL associated with the received data is:
http://server.dse:80/platform40/sensor12

At step 804, routing engine 140A then looks up the routing rules for the resource “platform40”, and finds rules relating to sensor11, sensor 12, sensor13 and device14. At step 806, routing engine 140A determines that only the rules for sensor12 match the received data. Assume that the routing rules for sensor12 are regular expression matches on the metadata:
metadata.match(/sensor12)

At step 822, routing engine 140A loads the resource bindings for the rules. Assume that the resource bindings for these rules are:

dse:/platform40/consumer20/sensor12
dse:/platform40/ DSEapplication102/sensor12
dse:/platform40/datastorage90/sensor12

At step 826, routing engine 140A provides the received data to the bound resources, namely protocol adapter 124C, application adapter 166B and data storage 90.

Application adapter 166B provides the data to DSE application 102 at FIG. 3B step 580, and at step 585, application 102 generates a data product based on the data from sensor 12, such as a current weather report.

Protocol adapter 124C provides the data caching reverse proxy 91C, which in turn provides it to secure socket proxy 90C and then to consumer 20. Consumer 20 generates a data product based on the data from sensor 12, such as an ideal price financial estimate for wheat futures.

Data storage 90 receives the data and stores it.

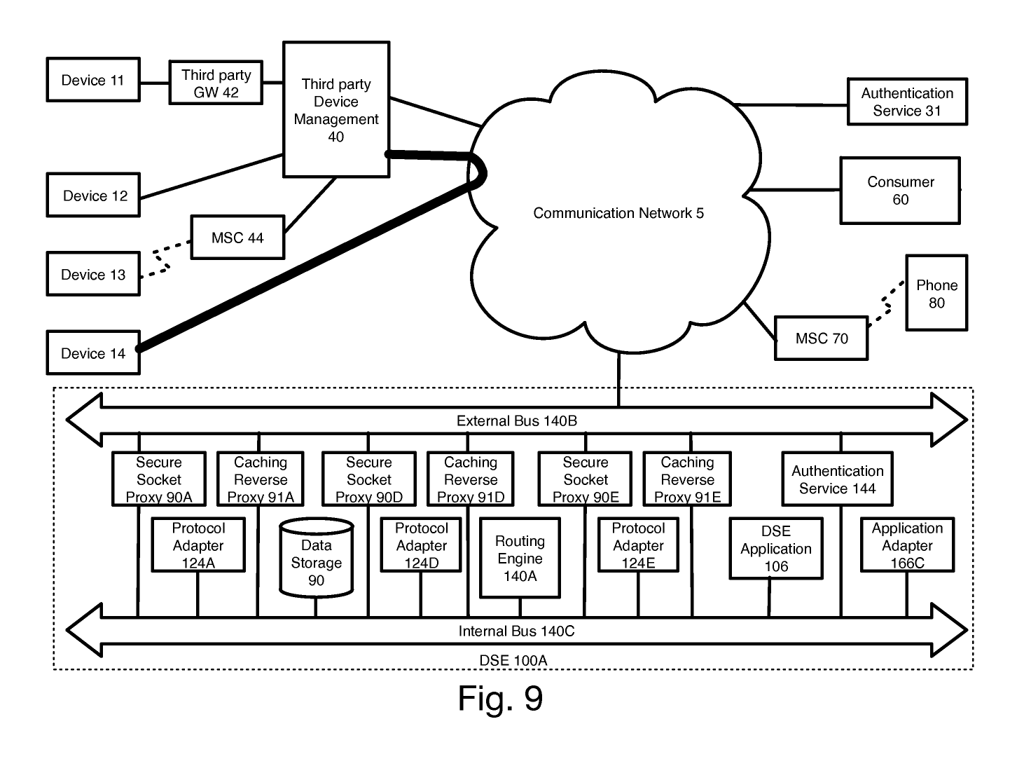

Another use case for DSE 100A will now be described with respect to FIG. 9. Operation is generally as described in the first use case, except as indicated below.

Authentication service 31 uses the UDP protocol.

Platform 40 uses the AMQP protocol.

Consumer 60 is a third-party application program that communicates with DSE 100A via secure socket proxy 90D, caching reverse proxy 91D and protocol adapter 124D. Consumer 60 uses the WebSocket protocol.

Mobile switching center (MSC) 70 includes a short message service (SMS) gateway that communicates with smartphone 80 via a wireless communication channel. MSC 70 uses the HTTP protocol.

DSE application 106 communicates with bus 140C via application adapter 166C.

Assume that an analyst having smartphone 80 wants an alert message sent to her smartphone when the output of temperature sensor 12 is above 90 degrees or below 30 degrees, and that sensor 12 has just produced a reading of 92. There are at least four different ways to configure DSE 100A to provide such alerts.

### First Configuration

The first configuration technique, providing alerts in near real-time, relies on third-party external application 60, also referred to as consumer 60, to receive the output of sensor 12, filter it, and send an alert.

Platform 40 sends a WRITE instruction to DSE 100A with a value sensed by sensor 12:
WRITE<source>platform40/sensor12, <date>2015sep25, <time>10:30:59, <value>92

Routing engine 140A has a routing rule that data for sensor 12 is to be sent to consumer 60:
dse:/platform40/consumer60/sensor12
   Accordingly, consumer 60 receives data from sensor 12, then checks whether the value of the data is above 90 degrees or below 30 degrees, and if so, sends an SMS message to MSC 70 for transmission to phone 80.

### Second Configuration

The second configuration technique, providing alerts in near real-time, relies on internal DSE application 106 to receive the output of sensor 12, filter it, and send an alert.

Platform 40 sends a WRITE instruction to DSE 100A with a value sensed by sensor 12:
WRITE <source>platform40/sensor12, <date>2015sep25, <time>10:30:59, <value>92
   Routing engine 140A has a routing rule that data for sensor 12 is to be sent to DSE application 106:
dse:/platform40/D SEapp106/sensor12
   DSE application 106 receives data from sensor 12, then checks whether the value of the data is above 90 degrees or below 30 degrees, and if so, sends a WRITE instruction to routing engine 140A:
WRITE <source>DSEapp106/sensor12, <date>2015sep25, <time>10:31:01, <value>92
   Routing engine 140A has a routing rule that DSEapp106 writes relating to sensor 12 are to be sent to phone 80:
dse:/DSEapp106/phone80/sensor12
   Protocol adapter 124E formats the data into an SMS message for phone 80, and sends it to MSC 70, that receives the SMS message and forwards it to phone 80.

### Third Configuration

The third configuration technique, providing alerts in near real-time, relies on third-party device management platform 40 to receive the output of sensor 12, filter it, and send a NOTIFY instruction to DSE 100A, where NOTIFY is a user-defined operation.

In addition to its normal WRITE operation for the output of sensor 12, platform 40 checks whether the value of the data from sensor 12 is above 90 degrees or below 30 degrees, and if so, sends a NOTIFY instruction to DSE 100A:
NOTIFY <source>platform40/sensor12, <date>2015sep25, <time>10:30:59, <value>92
   Protocol adapter 124A receives the instruction, authenticates it, and at step 674 of FIG. 7D determines that NOTIFY is a user-defined operation, so at step 794 of FIG. 7J, protocol adapter 124A retrieves the script for NOTIFY, which specifies a WRITE operation but with “alert” appended to the source:

```
NOTIFY {Source, Date, Time, Value}::
    WRITE <source>Source.“alert”, <date>Date,
    <time>Time,<value>Value
    ::
```

Routing engine 140A has a routing rule that alerts relating to sensor 12 are to be sent to phone 80:
dse:/platform40/phone80/sensor12.alert
   Protocol adapter 124E formats the data into an SMS message for phone 80, and sends it to MSC 70, that receives the SMS message and forwards it to phone 80.

### Fourth Configuration

The fourth configuration technique, providing alerts in near real-time, relies on third-party device management platform 40 to receive the output of sensor 12, and send it to DSE 100A as part of a WRNOTIFY instruction, where WRNOTIFY is a user-defined operation. In contrast to the third configuration, where platform 40 sends a normal WRITE instruction and a NOTIFY instruction, these are combined in the fourth configuration, and the script for WRNOTIFY determines that an alert should occur.

Platform 40 sends a WRNOTIFY instruction to DSE 100A with a value sensed by sensor 12:
WRNOTIFY <source>platform40/sensor12, <date>2015sep25, <time>10:30:59, <value>92
   Protocol adapter 124A receives the instruction, authenticates it, and at step 674 of FIG. 7D determines that WRNOTIFY is a user-defined operation, so at step 794 of FIG. 7J, protocol adapter 124A retrieves the script for WRNOTIFY, which specifies a normal WRITE operation, and if the value of the data is above a first threshold or below a second threshold, also specifies a WRITE operation with “alert” appended to the source:

WRNOTIFY {Source, Date, Time, Value}::

WRITE<source>Source, <date>Date, <time>Time,<value>Value
If (Value>90 OR Value<30) then
WRITE <source>Source.“alert”, <date>Date,
<time>Time,<value>Value
::

Routing engine 140A has its routing rules that are used for WRITE operations from platform 40, and also has a routing rule that alerts relating to sensor 12 are to be sent to phone 80:
dse:/platform40/phone80/sensor12.alert
   Protocol adapter 124E formats the data into an SMS message for phone 80, and sends it to MSC 70, that receives the SMS message and forwards it to phone 80.

Another use of DSE 100 will now be described with reference to FIG. 10A, corresponding to the pizza delivery example presented above with respect to FIG. 1.

Consider the case in which courier 6050 receives a notification, via DSE 100, to deliver pizza container 6060 to customer 6080. Courier 6050 needs vehicle 6000, with which to pick up pizza container 6060, and deliver pizza container 6060 to customer 6080's location.

First, owner 6020 of vehicle 6000 announces that his vehicle is available for use by ride-sharing service 6030, by publishing a message to the dse:/availability resource. The message is sent with meta-data indicating the vehicle:
dse:/availability/vehicle1000
   Ride-sharing service 6030 has a consumer program bound to the availability resource, watching for such notifications, using a binding such as:
dse:/availability/rideshare.in/vehicle.*
   The /vehicle.*/ expression binds all messages with metadata starting with the characters ‘vehicle’. Upon receiving notification of vehicle 6000's availability via their bound resource dse:/rideshare.in, ride-sharing service 6030 updates their internal database. Ride-sharing service 6030 may share this data with their proprietary analytics service 6045, to help analytics service 6045 predict demand for rides and determine the best pricing and routing strategy for ride sharing service 6030's available inventory of vehicles. The dse:/availability supply side data may be merged with demand side data from logistics platform 6040 by ride-sharing service 6030. To effectuate the merging, ride-sharing service 6030 subscribes to the anonymized dse:/deliveries data feed from logistics company 6040 to better match supply with demand. Analytics service 6045 runs another consumer program with a binding such as:
dseideliveries/logistics.in/.*
   that takes all of the delivery data and places it in a dse:/logistics.in resource, which analytics service 6045 uses to gather delivery data.

The results of analytics service 6045 are manually studied and used by the staff of ride-sharing service 6030, via regular desktop software. There is no requirement that the application itself need render all or any of its output back to the DSE 100. At this point, the ride-sharing service staff could issue a command to vehicle 6000, via a dse:/vehicle resource, instructing vehicle 6000 to drive itself to a location near the pizza parlor that the staff of ride-sharing service 6030 has determined will be a likely location for a pick-up based on analytics service 6045. Vehicle 6000 is now in closer proximity to where it is likely to be needed, reducing turn around time.

When customer 6080 calls pizza parlor 6070 to place their typical order, at 4:30 p.m. on a Friday, pizza parlor 6070 prepares their customer's “saved favorite” order of a large cheese and pepperoni pizza. When the pizza is cooked, the staff of pizza parlor 6070 places the pizza in smart pizza container 6060. The staff of pizza parlor 6070 provides the order information, including identification of pizza container 6060, by sending a message to the dse:/orders resource. This resource is bound to pizza container 6060 based on a routing rule set by logistics company 6040, dse:/orders/box/parlor. These routes and resources were provisioned by logistics company 6040, prior to delivering a shipment of smart pizza containers to pizza parlor 6070. The dse:/orders resource could also be bound to an application on the consumer's phone 6080, which is listening on a dse:/pizza resource with a binding of dse:/orders/pizza/parlor. When the pizza order is updated with the price and estimated time of delivery, the customer would be notified that his pizza is on its way.

Once pizza container 6060 is activated, it notifies logistics platform 6040, by publishing its copy of the order data to a dse:/box resource which is consumed by logistics platform 6040. Pizza container 6060 sends telemetry data to logistics platform 6040, so that the logistics company can maintain quality control over the delivery process. Logistics platform 6040 matches the telemetry data from pizza container 6060, with their database of the locations of each courier they monitor from their dse:/location telemetry feeds, and routes the nearest courier 6050 to pick up pizza container 6060. Once courier 6050 picks up pizza container 6060, she receives the delivery portion of the information from pizza container 6060's dse:/delivery data feed, and uses that to determine where she needs to deliver container 6060.

Courier 6050 acquires vehicle 6000, by contacting the ride sharing service over the dseitrips resource, forwarding the location data from the dse:/delivery feed. As courier 6050 steps out of pizza parlor 6070, vehicle 6000 arrives, picks up courier 6050, and transports her to customer's 6080's location. At customer 6080's location, courier 6050 initiates the payment reception using an application on her phone to connect the dse:/delivery data to the customer's dse:/orders data, and generate a payment event on the dse:/payment resource. The settlement procedure could then occur via whatever banks, payment processors, or telcos may be responsible for processing the data sent to dse:/payment.

FIG. 10B shows how DSE 100 is configured for the use case of FIG. 10A. Vehicle 6000, owner's phone 6020, courier phone 6050, pizza container 6060, pizza parlor 6070 and customer phone 6080 are each producers of data, and each communicates with one of secure socket proxy processes 90-1, 90-2. A secure socket proxy process typically accommodates up to thousands of incoming connections. A secure socket proxy process is chosen at random for an incoming connection, or according to some other technique.

Each secure socket proxy process provides data to one of reverse caching proxy processes 91-1, 91-2, 91-3, chosen at random or according to some other technique. Each reverse caching proxy process supplies information to one of protocol adapter processes 124-1, 124-2, 124-3, selected to accommodate the protocol of the information, and then randomly among suitable protocol adapter processes. The protocol adapter processes provide data to routing engine 140A, which routes the data in accordance with its routing rules. Data storage 90 stores information used by DSE 100, as described above. Auth service 144 provides authentication and/or authorization services for the protocol adapter processes, as described above.

Application adapter processes 166-1, 166-2, 166-3, 166-4 receive data from routing engine 140A, and provide the received data to their respectively coupled data consumers, tracking platform 6010, ride-sharing service 6030, analytics service 6045 and logistics service 6040.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A system for enabling a first data consumer to create a first data product, comprising:
a first protocol adapter executing on a computer for (a) receiving first data from a first data source in a first protocol, and (b) extracting first payload data from the received first data, the first data source operating independently of the first data consumer;
a routing engine executing on the computer for routing the extracted first payload data in accordance with a first routing rule; and
a second protocol adapter executing on the computer for (1) receiving the routed first payload data from the routing program, and (2) encapsulating the received first payload data according to a second protocol different than the first protocol, the second protocol being associated with the first data consumer;
wherein the first data consumer receives the encapsulated first data and creates the first data product based on the first payload data.

2. The system of claim 1, wherein the extracted first payload data is identified by a first universal resource identifier (URI), and the first routing rule specifies a first uniform resource locator (URL) associated with the first URI.

3. The system of claim 1, further comprising
a third protocol adapter executing on the computer for (a) receiving second data from a second data source in a third protocol, and (b) extracting second payload data from the received second data, the second data source operating independently of the first data consumer and the first data source, the third protocol being different than the first protocol and the second protocol;
and wherein
(A) the routing engine is also for routing the extracted second payload data in accordance with a second routing rule;
(B) the second protocol adapter is also for (1) receiving the routed second payload data from the routing program, and (2) encapsulating the received second payload data according to the second protocol; and
(C) the first data consumer also receives the encapsulated second data and creates the first data product based on the first payload data and the second payload data.

4. The system of claim 1, further comprising
a fourth protocol adapter executing on the computer for (1) receiving the routed first payload data from the routing program, and (2) encapsulating the received first payload data according to a fourth protocol different than the first protocol and the second protocol, the second protocol being associated with a second data consumer;
and wherein
(A) the routing engine is also for routing the extracted first payload data in accordance with a third routing rule; and
(B) the second data consumer receives the encapsulated first data in the fourth protocol and creates a second data product based on the first payload data.

5. The system of claim 1, further comprising an authentication service executing on the computer for authenticating the first data.

6. The system of claim 5, wherein the authentication of the first data persists for a predetermined time.

7. The system of claim 5, wherein the authentication service is for
retrieving an authentication rule for the first data, and
comparing the authentication rule to a requested resource path for the first data to authenticate the first data.
